(19) United States
(12) Patent Application Publication
(10) Pub. No.: US 2004/0078236 A1
(43) Pub. Date: Apr. 22, 2004

(54) Storage and access of aggregate patient data for analysis

(75) Inventors: Marcus Andrew Stoodley, Roseville (AU); Darryl Gordon Stuart, Neutral Bay (AU)

Correspondence Address: SPECKMAN LAW GROUP, 1501 WESTERN AVE, SUITE 100, SEATTLE, WA, 98101, US

(73) Assignee: MEDTAMIC HOLDINGS, St. Leonards (AU)

(21) Appl. No.: 10/648,650

(22) Filed: Aug. 25, 2003

Related U.S. Application Data
(63) Continuation-in-part of application No. 09/430,782, filed on Oct. 30, 1999, now Pat. No. 6,611,846.

(51) Int. Cl. G06F 17/60

(52) U.S. Cl. 705/2

(57) ABSTRACT

The storage and retrieval of healthcare information is provided by use of a database that facilitates a number of different tasks that require manipulation of patient data. Comprehensive patient data representing a group of patients may be retrieved based on patient descriptive categories including diagnosis, e.g. anatomy, pathology or clinical presentation as well as treatment and outcome factors of each case. Symbolic codes assist in storage and retrieval of some of the data. In storage, various of the patient data related to particular patient issues and events may be linked for easy retrieval of relevant data. The catagories include data options that may be organized in the form of a hierarchical tree that has branching levels of data options with increasing specificity. Data from the various levels may be compared, as well as data between individual categories. In some embodiments, selected multimedia data may also be accessed based on criteria from data options of the patient descriptive categories.

### REFERENCE TO RELATED APPLICATIONS

This application is a continuation-in-part application of U.S. patent application Ser. No. 09/430,782, filed on Oct. 30, 1999 and issued on Aug. 26, 2003 as U.S. Pat. No. 6,611,846, the contents of which is incorporated herein.

### NOTICE OF COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to the storage, retrieval and analysis of healthcare information using a computer, and more particularly to computer-based systems for analyzing a comprehensive collection of healthcare patient data for multiple patients through the use of a healthcare database.

### BACKGROUND

During the course of patient's experience in obtaining healthcare, a variety of “patient data” are generated to describe the patient's encounter with a healthcare professional. The patient data may also relate to past healthcare experiences as well as general demographic data regarding the patient. The patient data are of interest to many professionals in the healthcare field. There are numerous tasks in which it is useful for professionals to analyze the patient data, such as for billing purposes, research and analysis, including research publications and presentations, quality assurance reviews, clinical trials, patient management, training of medical professionals, maintaining professional licenses and certifications, informed consent and risk mitigation programs, entering data into electronic medical record (EMR) systems, etc. Some of these circumstances may occur at various sites. Oftentimes, the same or similar data must be manipulated at different times during the course of patient care and at any time thereafter. It is often useful to retain the patient data in a manner that is readily available for future evaluation.

Traditional procedures to keep data often limit access to the data. Patient information is frequently stored on hard copy files and forms and in large electronic storage archives, e.g. hospital information systems (HIS). Such storage mediums usually only contain data from a local healthcare site and not data from remote locations.

Moreover, within a facility, oftentimes various departments need to manipulate the same or similar types of the patient data. Rather than accessing a comprehensive body of patient data and pulling out the parts that they require, they often rewrite the data, such as into a specialized database or departmental forms. For example, the billing department of a hospital may require special codes and general descriptors of patient data relating to a patient's treatment to be written on a form, whereas a mortality and morbidity (M&M) review board may require more specific information regarding the treatment and its outcome in a report. This rewriting of data is redundant and needlessly time consuming.

Some traditional storage means assist in retrieval of information about individual patients. However, it is also very useful to view multiple patient data in aggregate, such as, in order to compare the data or acquire a list. Transformation of raw clinical data into comprehensive information provides invaluable knowledge to perform a wide variety of tasks. For example, the access and review of patient data from cases having similarities to a current case may assist in training a professional for the treatment of a patient.

The availability of information for use in analysis is critical for conducting fair assessments of care. Precise definitions of all the terms used should be stored in a manner that permits retrieval in order to avoid inaccurate reporting. Comparisons across patients and healthcare institutions require adequate description of those patients studied in order to group those having comparable probabilities in response to other treatment, i.e. must discriminate between groups of patients. The data should also be useful in plotting the course of illness. Rules for ranking data should be objective, reproducible, meaningful and reliable.

Furthermore, a comprehensive selection of related data that is appropriate for a given task must be stored and be able to be accessed. Excluded information may result in skewed conclusions. For example, where an audit is performed on outcomes of one treatment regimen, e.g. surgery, descriptions of clinical presentations and other treatments related to the treatment procedure should be considered. Otherwise, medical practitioners who refuse particular treatments for advanced cases may produce more favorable outcome data than the results for the remaining treated patients. If no treatment is performed, this information should be recorded and taken into consideration in the assessment of outcomes and quality assurance. In addition, if some risk factors are excluded from the data, a higher observed-to-expected ratio results. Gaming may also occur, where risk factors are over reported by a healthcare facility. Related data should be stored in a manner that allows for cohort studies in determining factors associated with good or bad outcomes.

With current data storage procedures, incomplete patient information is typically stored and accessible for limited use. The patient data often takes the form of free text that is difficult to search or standard codes that represent only a portion of a patient's healthcare experiences. For example, the standard, International Classification of Diseases-9 (ICD-9) and International Classification of Diseases-10 (ICD-10) by the World Health Organization, generally indicate the pathology of medical conditions. Another standard code system, Current Procedural Terminology (CPT) codes by the Health Care Financing Administration (HCFA) and maintained by the American Medical Association (AMA), includes five (5) digit numbers to classify some medical or psychiatric procedures performed by physicians and other health providers. The codes were developed to assist in the assignment of reimbursement amounts to providers by Medicare carriers. Although these code systems are periodically updated, ICD-9, ICD-10 and CPT codes are insufficient to accurately conduct most patient data analyses. These current standard codes depict only a small portion of the medical information that is useful for specific analytical applications. The ICD-10 codes do not allow for cross comparison between branches of data options and only has limited descriptive information. The amount of detail is only adequate for generic task use across many medical specialties, such as for billing. Thus, there is insufficient detail for multiple task use.

Another problem with the use of solely current standard code sets is that the selection of these codes to represent the diagnosis of a patient's condition may be biased by various factors, such as the specialty of an admitting physician. For example, in coding for cerebrovascular disease, where the admitting physician is a surgeon, the discharge coding may reflect the condition of specific arteries, whereas if the physician is a neurologist or internist, the code assignment may be more likely to reflect the symptomatic status of the patient. See Inaccuracy of the International Classification of Diseases in Identifying the Diagnosis of Ischemic Cerebrovascular Disease, Neurology, 1997, Sept. 49:3,660-4. Moreover, for some conditions, the coding system does not have a sufficient choice of data options to accurately reflect the condition. See Limits of ICD-9-CM Code Usefulness in Epidemiological Studies of Contact and Other Types of Dermatitis, Am J Contact Dermat., 1998, Sept. 9:3, 176-8. As a result, frequently such codes have proven to be inaccurate or incomplete representations of patients' conditions.

Moreover, it is advantageous for data storage and manipulation mediums to be flexible, so as to accommodate a variety of data. Patient data may take numerous forms, including text, images and video, or variations thereof, such as image overlay data, measurements, coordinates, etc. Data may also be in the form of time-dependent data including sound, such as audio dictation, and waveform data. The data may also be static representations of time-dependent forms, such as curves.

The data may also be recorded in different languages depending on the user's nationality. Where many users enter a data using different languages, a single text meaning for data may have many symbolic forms that cannot be recognized as being similar by a database. Thus, current storage systems have limited use across multiple language barriers.

Furthermore, according to most current practices, multimedia data are generally archived by healthcare facilities by a patient identification number. Hence, there is no mechanism to readily access multimedia data that relate to particular patient descriptions, such as treatment, anatomy, pathology, etc. Instead, a patient list must be generated and each individual patient's multimedia records retrieved for review. This process is tedious and inefficient for analyses across large numbers of patients and complex investigations.

Thus, in light of the shortcomings of the various currently available systems, there is still a need for systems that enable simple access to many types of data and from several healthcare sites. The system should allow for searching across multiple layers of variables. In particular, there is a desire for a computer-based system that allows for storage and manipulation of a highly descriptive body of patient data that is useful in conducting multiple tasks.

### SUMMARY OF THE INVENTION

The computer-based system of the present invention is useful in storing a cohort description of data to describe a group of patients in an organized manner. The type of data that is stored and the relational manner in which they are stored, allow for comprehensive searches to retrieve aggregate data of multiple patients. The patient data may be stored for more than one provider.

Patient data is created by selection of data options from a comprehensive list of data options in one or more categories. At least some of the categories reflect the type of encounter a patient may have with a healthcare personnel. The categories generally include diagnosis, treatment and outcome. The diagnosis category may be further specified in past history, clinical presentation, pathology, and/or anatomy categories. The treatment category may be further specified in operation, procedure and/or diagnostic study categories. The outcomes category may be further specified in clinic visit outcomes score, admission outcomes score, discharge outcomes score, complication, disability, and/or cause of death categories. Additional categories may also exist. Various of the categories are linked within the data structures of the system to relate data in different categories of a given patient management cycle for a patient's particular condition. In this manner, multiple instances of diagnoses, treatment procedures, admissions and clinic visits may be recorded.

Tables that store the data for some of the categories may also include a different symbolic code to represent a descriptor of patient data within the categories. In one embodiment, a single symbolic code may represent different language interpretations of a descriptor. The symbolic codes may be numeric, alphanumeric and/or may comprise other symbols. Symbolic codes may be provided for diagnosis, clinical presentation, anatomy, pathology, demographics, past histories, etc. Often, the data options of the categories are arranged in a database within one or more of the tables by increasing levels of specificity in a hierarchical tree. The patient data are stored with a unique patient identifier to relate all of the patient data within a data set. In this manner, an aggregation of patient data representing various healthcare encounters of groups of patients, as well as other related data, may be tracked for future retrieval.

The present database stores data that may be retrieved to perform multiple tasks by the system. At times, the data may be entered by a user for one task and then extracted by another user for at least one additional task. For example, the tasks may include at least two, three, five or more of the following tasks: applying the data to patient management, such as acute inpatient and non-acute outpatient reporting; clinical outcomes tracking; training of healthcare professionals; clinical trials, such as bidding, conducting and analysis of clinical trials; healthcare research and analysis, such as academic research; quality improvement in the quality of care; fulfilling certification or accreditation requirements; informed consent tracking, risk mitigation assessment; access to multimedia files linked to treatment events; preparation of publications and presentations, data collection for export to other database systems including electronic medical record (EMR) systems; billing including data collection and validation; etc. The task performed by the system may also include creating of reports for at least two of an audit, a mortality and morbidity list, reporting data, a discharge list and an accreditation case log. The task by the system may further include transferring the patient data to a form for patient management, clinical outcomes tracking, fulfilling certification or accreditation requirements, clinical trials, quality improvement assessment, informed consent tracking, risk mitigation assessment, and billing.

In retrieving patient data, a user conducts a search of stored data by selecting at least one criterion for particular patient data from at least one of the categories. The particular patient data of all patients in a group matching the criteria are retrieved.

At various times, the patient data are selected from a list of data options within at least two of the categories, such as treatment and outcome, at least three of the categories, at least four of the categories or all available categories. At still other times, at least one of the data options in at least one of the categories is related to custom data provided in a custom screen table that is created by a user and stored within the database.

In some methods, multimedia data that are related to the particular patient data by the identifier is retrieved. The multimedia data may include video, image, electronic waveform and sound data, and the like, or combinations thereof. In some cases, the multimedia data is retrieved from a storage component in the relational database. In other instances, the multimedia data is stored on a remote server that is communicatively coupled to the relational database, and retrieved therefrom. In any event, some or all of the multimedia data may be selected and conveniently transferred to a file, such as a presentation file.

A healthcare patient data analysis system for use in employing the above described methods typically includes a processor; an input device in communication with the processor for receiving patient data and a storage unit in communication with the processor. The storage unit has a relational database for storing data options within data option category tables by increasing levels of specificity in a hierarchical tree. The data option category tables are selected from the group consisting of diagnosis category, e.g. clinical presentation, pathology, and anatomy, treatment category and outcome category. The system is further used for storing patient data of a data set having a unique patient identifier within category tables, the patient data being chosen from the data options in at least one data option category table. The processor has a means for receiving patient data from the input and storing the patient data in the storage unit; a means for receiving instructions from the input for selecting at least one criterion for particular patient data from at least one category table; and a means for retrieving the particular patient data. In one embodiment, a display that is in communication with the processor is provided.

Still other embodiments may provide a computer readable medium having stored therein a plurality of sequences of instructions, which, when executed by a processor, cause the processor to perform certain steps. Of course, other embodiments may provide only the instructions themselves or the instructions as carried in a data signal by a carrier wave. Among the steps may be included the step of receiving selected patient data from an input device. The patient data is selected from data options in at least one category including diagnosis, treatment and outcome.

Another step may be determining whether the patient data includes an identifier. If no identifier is present, the processor attaches a unique patient identifier to the patient data of a data set, each data set being for a different patient. The patient data is stored in a relational database with the unique patient identifier within tables of one or more categories. The categories may include diagnosis, e.g. past history, clinical presentation, pathology, and anatomy, a treatment category, e.g. operation, procedure and diagnostic study, and a outcome category, e.g. clinic visit outcomes score, admissions outcomes score, discharge outcomes score, complication, disability and cause of death.

A further step may include storing a linking event identifier for corresponding linking event data to link at least some of the patient data related to a patient management cycle. The patient management cycle includes the first presentation of a patient for a particular healthcare issue until the absolute completion of treatment and thereafter a follow-up period of time to assess the effect of treatment, such as days, weeks or years. The linking event data may be patient data of the diagnosis category. The linked data may be patient data in the treatment category and the outcome category, such as outcome score data. The linked data also include admission score and discharge score.

One or more user interface(s) are provided to permit the user to allow a user to selectively view data options to be selected by the user and entered through the input device as patient data. At least one of the user interfaces may be custom created by the user and linked to a data option of another user interface. The user interface may also permit a user to view retrieved patient data for all data sets in a group matching a criterion.

### BRIEF DESCRIPTION OF THE DRAWINGS

The present invention is illustrated by way of example, and not limitation, in the figures of the accompanying drawings in which:

FIG. 1 depicts a block diagram of one embodiment of the data analysis system comprising a user station, in accordance with one embodiment of the present invention.

FIG. 2 depicts a table illustrative of one data structure used in embodiments of the relational database to store data options for a provider patient identifier, in accordance with one embodiment of the present invention.

FIG. 3 illustrates an example of a display screen for data entry of diagnostic category data into one relational database in accordance with one embodiment of the present invention.

FIGS. 4A-4E illustrate examples of display screens for data entry of treatment category data into one relational database in accordance with the present invention, wherein FIG. 4A shows an operation screen with an operation codes window, FIG. 4B shows an operation screen with surgeons window, FIG. 4C shows an operation screen with a related diagnosis window, FIG. 4D shows an operation screen a billing codes window and FIG. 4E shows an operation screen with a diagnostic studies window.

FIGS. 5A-5B depict tables illustrative of some of the data structures used in embodiments of the relational database, wherein FIG. 5A shows an operation table containing data entered in an operation display screen and FIG. 5B shows a table of operation codes entered in an operation display screen and linked to the operation table, in accordance with one embodiment of the present invention.

FIGS. 6A-6B illustrate some display screens including treatment fields, wherein FIG. 6A shows an admissions screen and FIG. 6B shows a clinic visit screen.

FIG. 7 illustrates a display screen for demographics data, in accordance with one embodiment of the present invention.

FIG. 8 illustrates an images screen, in accordance with one embodiment of the present invention.

FIG. 9 illustrates a display screen for test results for a given patient, in accordance with one embodiment of the present invention.

FIG. 10 depicts a flow diagram of one method of storing healthcare patient data, in accordance with the teachings presented herein.

FIG. 11 depicts a table illustrative of one data structure used in embodiments of the relational database to store data options for an anatomy category, in accordance with one embodiment of the present invention.

FIGS. 12A-12C depict examples of display screens for searching for particular patient data from data stored in one relational database in accordance with some embodiments of the present invention, wherein FIG. 12A shows one embodiment of “search for” screen, FIG. 12B shows a graphical search result screen, and FIG. 12C shows a main records screen with task controls to conduct searches for particular tasks, according to embodiments of the present invention.

FIGS. 13A-13D illustrate examples of analysis screens, wherein FIG. 13A shows an analysis search screen, FIG. 13B shows an admission results screen, FIG. 13C shows a diagnosis results screen, and FIG. 13D shows an operation results screen, according to embodiments of the present invention.

FIG. 14 depicts an example of a presentation screen for presenting particular patient data resulting from a search of patient data stored in one relational database, in accordance with one embodiment of the present invention.

FIG. 15 depicts a block diagram of one embodiment of a healthcare data analysis network system configured, in accordance with the teachings presented herein.

### DETAILED DESCRIPTION

A healthcare data analysis system is provided, which includes a relational database to organize and to store detailed patient data for numerous patients and to easily retrieve an aggregate of patient data for groups of patients. Methods are provided to permit storage of a rich collection of facts of multiple patient encounters with healthcare professionals in a manner that enables straightforward searching of the detailed facts with the use of symbolic codes.

The present database provides sufficient data categorized and linked in storage tables to be useful in a variety of tasks that require such data. By comparison, previous patient databases provide for storage of cursory facts in a manner that limits retrieval of related facts and are, thus, limited in their application of different tasks. Comprehensive patient data may be stored and retrieved based on patient descriptive categories including diagnosis e.g. past history, clinical presentation, pathology, and anatomy; treatment, e.g. operations, procedures and diagnostic studies; and outcome, e.g. clinic visit outcomes score, admissions outcomes score, discharge outcome score, complication, disability and cause of death factors of each case.

The patient data may relate to any of a variety of healthcare specialty fields including neurosurgery, orthopedics, radiation oncology, cardiology, general surgery, etc. Oftentimes, a database is designed to be specific to one healthcare discipline.

The patient data for each patient are grouped together into a separate data set in which the data are related to each other in tables by a patient identifier. The patient data within the database are stored in the tables as selected data options. In one embodiment, at least some of the data options may include a descriptor and a distinctive symbolic code associated with each descriptor. The categories include at least two data options that may be organized in the form of a hierarchical tree branching into multiple levels of data to be searched. Data from the various levels may be compared, as well as data between separate categories. In some embodiments, selected multimedia data may be accessed based on criteria from data options of the patient descriptive categories.

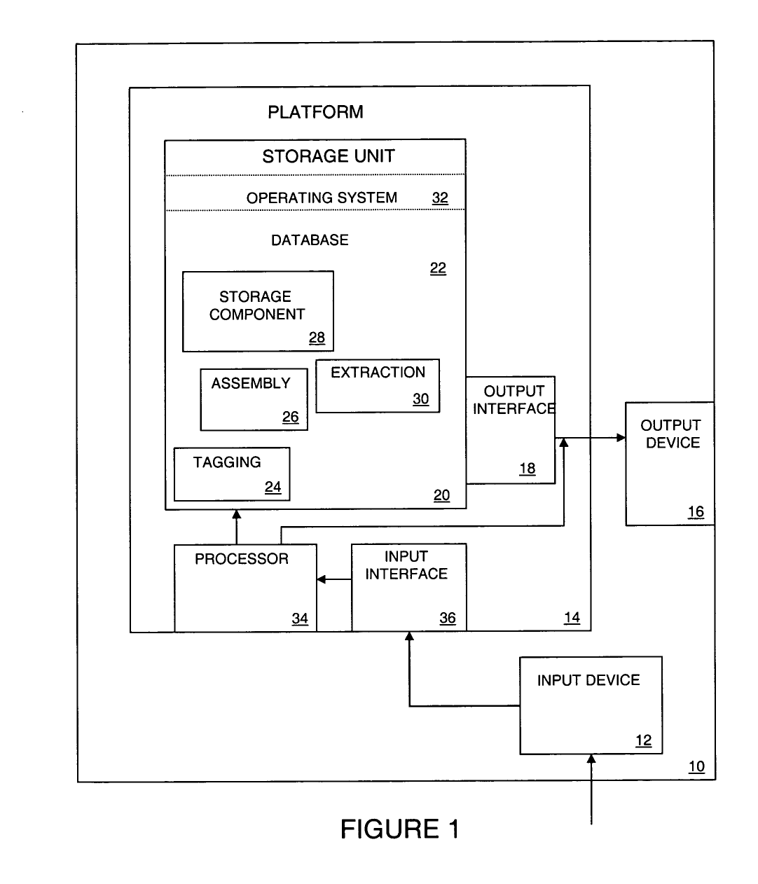

In one configuration of the data analysis system, client-based architecture is used where storage, data processing and computations are performed on one or more user stations. FIG. 1 shows one such data analysis system comprising a user station 10 that is suitable for performing the present method for use of the healthcare patient database. An input device 12 transmits instructions and/or data from a source to a platform 14. The platform 14 is in communication with an output device 16, such as a display, through an output interface 18, such as a display controller. The output device, e.g. display, may depict a user interface that allows a user to selectively view data options to be selected by the user and entered through the input device as patient data. The user interface may also permit a user to view selected patient data for all data sets in a group matching a criterion.

The platform 14 contains a storage unit 20, a processor 34 and an input interface 36 for communicating to the input device. The storage unit 20 has a database application 22 (“database”) for storing, manipulating and retrieving patient data and an operating system 32. The database 22 includes a tagging component 24 for attaching identifiers to the patient data, an assembly component 26 for organizing patient data, a storage component 28, and an extraction component 30 for retrieving particular patient data from storage.

The user station platform 14 may be a personal computer (PC), Macintosh®, or one of a wide variety of hardware platforms that runs the operating system 32. The platform may read and write to and from its storage unit 20. As will be readily apparent to those of ordinary skill in the art, other hardware may be used to execute the software. The operating system may be Windows®, UNIX® or other conventional operating software. A “user”, as referred to herein, is a person who accesses the database for storage and/or retrieval of data. In some embodiments, one or more users may store the data and one or more different users may retrieve the data to perform a variety of healthcare-related tasks. The user is typically a healthcare professional, such as a doctor, nurse, hospital administrator, etc.

The database 22 may be implemented on a variety of commercially available authoring packages. In some embodiments, the software is written in C++ with a database tool kit, such as Microsoft SQL Server®, from Microsoft Corporation, located in Redmond, Wash.

The processor 34 communicates with the database 22 from storage unit 20 to get pieces of code and processes the code. The processor 34 manipulates patient data in accordance with requests from the input device 12 and operates the output interface 18. Processor 34 may have memory, such as random access memory, as is well known in the art.

The storage unit 20 may be any device capable of storing data for a long period of time, either as a component of the platform 14, as shown in FIG. 1, or as a separate entity that is coupled to the platform 14. Although any appropriate storage capacity may be used, the capacity is typically at least ten megabytes and more usually at least twenty gigabytes. Extended storage capabilities are required where multimedia data are stored on the user station. Adequate hard disk space, e.g. 20 GB per 500 patients, or an archiving system, such as CDROM/DVD burner or tape back, up may be used for archiving multimedia data. The storage unit may be integrated with the platform or removable from the system. For example, the storage unit 20 may be a floppy disk drive, Bernoulli hard drive, Winchester hard disk, analog tape drive, digital tape drive, optical disk drive, magneto-optical drive and floppy disk. In addition, the present invention anticipates other storage devices. All of the aforementioned storage units are by way of example and are not intended to limit the choices that are or may become available in the art.

The input device 12 may be configured to receive data or signals directly from a user. Conventional input devices are keyboards, mouses, microphones, a touch display screen, personal data assistant devices (PDA's), telephones, e.g. cell phones, pen-to-text data entry devices, e.g. IBM ThinkPad Untethered Stylus from IBM Corporation, and the like. In one instance, a user may enter data into database data entry screens in a PDA and transfer the data into the database of a main computer system or server through electronic syncing, infrared light beaming, etc. In another instance, a user may speak the data into a telephone and the input interface is voice recognition software couple to the database permit translation and entry of the data into the database storage component. The input device may also be another intelligent device or computer and the data is entered into the database storage through a network, e.g. the Internet, a virtual private network, etc.

The input interface 36 may be a wireless or wired interface. For example, the input interface may be designed to support wireless connections from a network access point. Some embodiments of the input interface 36 may include optical interfaces including wave guides and spatial transmitter/receiver devices such as an infrared (IR) port or radio frequency (RF) receiver for communicating with a handheld device. Other embodiments of input interface connections may include short-range radiant energy signals such as those that support the technology commonly referred to as Bluetooth. de facto standard (Specification of the Bluetooth System, Version 1.1, Feb. 22, 2001) and 802.11a standard (IEEE Standard 802.11 a-1999, available on the Institute of Electrical and Electronics Engineers web site, http://standards.ieee.org/reading/iee- e/std/lanman/802.11a-1999.pdf). Furthermore, digital still images may be downloaded onto the user station by a USB or Firewire cable.

Other types of input devices are data generating modalities. Exemplary medical modalities are data acquisition equipment for magnetic resonance imaging (MRI), computed tomography (CT) ultrasound (US), nuclear medicine (NM), digitized radiography (DR), computer radiography (CR), electronic waveform devices to collect EEG and ECG data, etc. Other modalities include photographic devices, such as high resolution digital cameras, video capture interfaces, such as Snappy@ brand parallel port video capture devices, scanners, capture devices for endoscopy and microscopy, etc.

Data may be collected from other database schemes and imported into the present analysis system. Files may be imported in their native mode and the data may be inserted into the relevant fields in the database. In one embodiment, File Transfer Protocol (FTP) may be used to transfer the file to the present system for processing. The native import mode for the present analysis system may be an XML-type layout, to easily use other file formats. A report may be created to summarize the session. In one embodiment, a continuous processing mode is used for updating by automatically monitoring a directory for the presence of a new import file and processing any new file that is found. The new imported file will be renamed. A unique patient identifier is attached to a report file for each imported file and then the automatic update returns to monitoring the directory for a next file. In this manner, patient data may be routinely imported when the patient data is entered into another information system, obviating the need to re-enter data already available form other system sources.

In addition, other input devices and interfaces that transfer data to the platform are within the intended scope of the present invention. The input devices and interfaces listed herein are described by example and are not intended to limit the input devices that exist or may exist in the future and may be employed with the present analysis system. Furthermore, in some embodiments of user stations, multiple input devices are present.

The output device may be a handheld device, such as personal data assistant devices (PDA's), telephones, e.g. cell phones, smart phones, etc. For example, the user may contact the database via telephone and request a search by speaking search terms or entering terms through a graphical interface which are sent through the Internet. The search results may be then “read” to the user via an interactive voice response synthesizer or displayed on a graphical interface. Other output devices may include a display, printer and facsimile machine. Where the output device is a display, the display may be any one of a number of conventional display devices, such as a liquid crystal display or video display.

The output interface may be the same or similar wired or wireless interfaces described above with regards to the input interface. The input and output interfaces are not limited to any particular wired or wireless interfaces. Furthermore, the invention is not limited to any particular number, type, or combination of interface adapters. For example, the present invention may be adapted to more than two network interface cards. Additionally, a combination of wireless and wired interfaces may be provided.

It should be noted that the present invention anticipates other components and configurations of the components in the user station of the data analysis system.

Data Storage

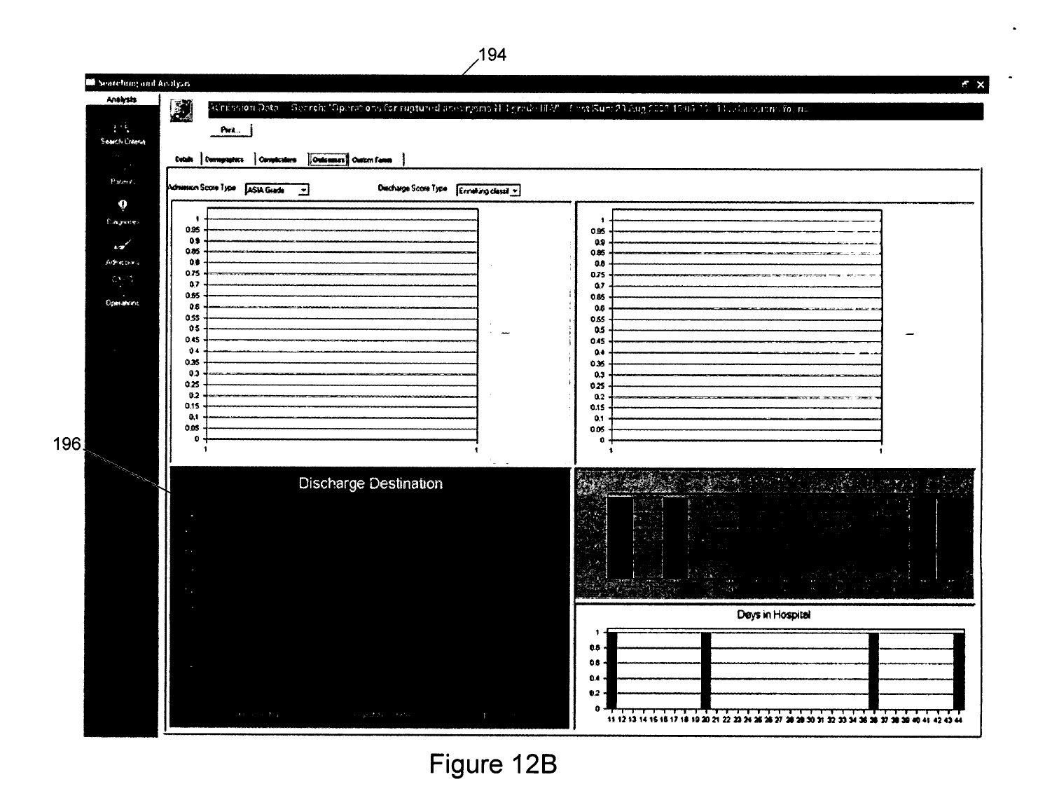

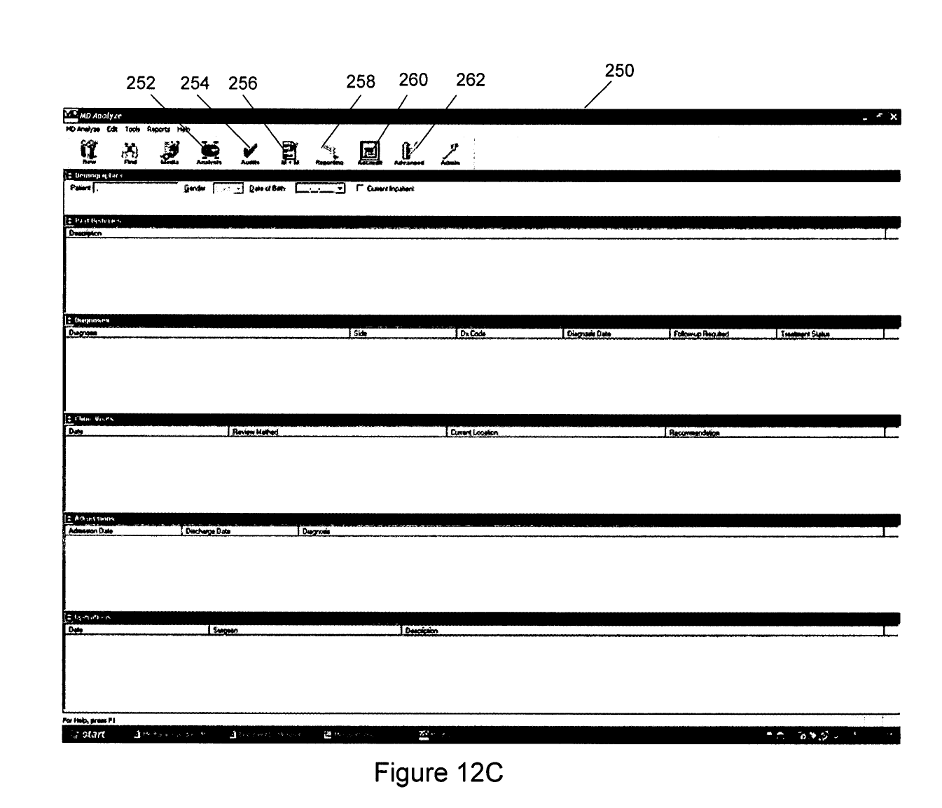

In order to store healthcare patient data, the user typically prompts the platform to prepare for data entry through the input device. In one embodiment, the user may initiate a request for a data storage screen to appear on the display, usually by selecting from a main menu user interface screen, such as the main records screen shown in FIG. 12C and described below. The user may also specify the healthcare specialty for which the database is to be used. For example, the user may select a button on the main menu screen that instructs the database that the specialty function is to be neurosurgery, orthopedics, cardiology, or the like. The database will adapt to present to the user the appropriate display screens, menus and data option lists for the select specialty area.

Portions of patient data comprising a data set may be entered at various times and collected from different sources. A patient encounter may occur at one of numerous healthcare facilities and/or by a variety of healthcare professionals. The encounters of a given patient may be logged into this central database no matter what facility or professional conducts the healthcare activity. Each data set is a collection of patient data for an individual patient, recognized in the database by the identifier, that is unique for each patient and which is the same identifier used even if the data is entered by different healthcare facilities or by/for different healthcare professionals. All data of a data set for a patient is correlated into this single patient identifier, so that all data of a data set may be searched and retrieved.

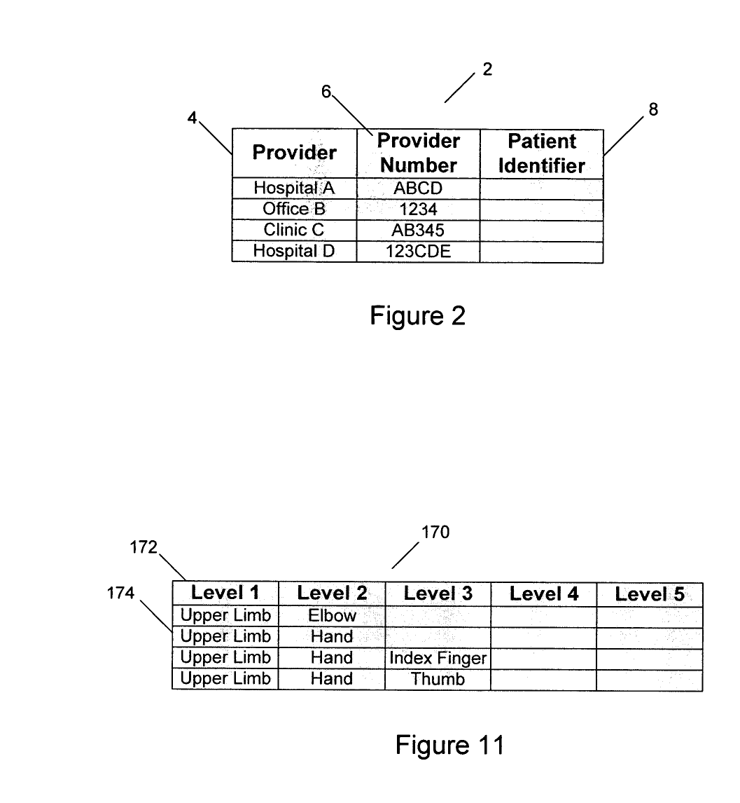

Each healthcare facility that enters patient data typically has its own format of a provider-based identifier, which may be numeric, alphanumeric, or a combination thereof, to represent patients who are cared for at that facility. The database structure includes a table that relates provider-based identifiers for a patient to the unique patient identifier. FIG. 2 shows one example of a provider patient identifier table 2 having a column for the provider site 4, a column for the provider-based identifier 6 and a column for the patient identifier 8 used by the system. The patient identifier is usually a program code sequence. The database may further recognize the format style of an identifier as a format that is used by a particular facility. When additional data is entered for a patient having data already in the database, the provider-based identifier is matched with its unique patient identifier. In one method, when data is entered all provider-based identifiers for a particular provider are searched in order to obtain the matching unique patient identifier. In this manner countless numbers of facilities may utilize the present database to store and access patient data. Therefore, the collection of data may represent a patient's entire experience in obtaining healthcare from any facility.

Patient data are available for a plurality of different patient experiences in the form of data options. Data options often include both a descriptor, e.g. text, and/or an associated symbolic code, e.g. numeric, alphanumeric, symbols or combinations thereof. The symbolic codes compose a universal code set that may be used to represent descriptors in any language. Thus, any language used to describe a data option may be translated into the same symbolic code. In this manner a data option may be indexed under its associated symbolic code and used across multiple languages, creating a multi-lingual environment for the present data analysis system.

The data of a category is stored in one or more separate and related category tables. The data tables of a data set are structured to reach full normalization according to the patient identifier. In order to achieve normalization, several tables have links to other tables. For example, a first table may link to a second table that contains the descriptive codes for the first table. This structure allows a virtually unlimited number of codes to be entered for each category.

Furthermore, there may be a main table to which other tables are linked by the internally generated identifier. For example, the main table may be used to store patient demographics.

A patient's encounters from the first presentation for a particular healthcare issue until the absolute completion of treatment and follow-up may be tracked as a “patient management cycle”. Some encounter types include referral interview, outpatient consultation, outpatient procedure, inpatient consultation, inpatient procedure, hospital admission, emergency admission, diagnostic study, etc. The present invention provides an opportunity to store detailed descriptions of one or more patient's encounter that may be specific for a particular healthcare discipline.

In one particular method of providing deep levels of detail, the data options are hierarchically arranged from general to more specific descriptors under each category. Any number of levels of data options may be available, such as 2 to 10 levels, and usually 3 to 5 levels. The branches of data options for each category may be depicted on a display screen in the form of a hierarchical tree where the levels of data options are graphically shown. The user may conveniently enter data by pointing to the data option at a particular level and selecting the option. In one embodiment, the user may also define special terms to add to the data option list, such as terms for diagnosis, co-morbidities, operations, complications and sequela and outcomes scales.

In order to facilitate data storage, the symbolic codes are unique for each descriptor, which may be presented in a variety of languages. Symbolic codes for the levels of a hierarchical branch of data options may be related as a family of codes, which may be divided into groups. For some categories of data options, the same or similar symbolic codes may be used for various categories. For example a past histories category and diagnostics category may both use element of the same codes for data options. Some code sets may include, diagnostics, past history, occupation, cause of death, anatomy, pathology, clinical presentation, disabilities, procedures, billing codes, clinic visit outcome scores, related diagnosis for each outcome, admission outcome score, discharge outcome score, complications, related operation codes for each complications, media types, etc.

In one embodiment, diagnostic and past history families of symbolic codes may include numerous groups including the descriptors: infectious and parasitic diseases; neoplasms, endocrine, nutritional and metabolic diseases and immunity disorders; diseases of the blood and blood-forming organs; mental disorders; diseases of the nervous system and sense organs, diseases of the circulatory system; diseases of the respiratory system; diseases of the digestive system; diseases of the genitorurinary system; complications of pregnancy, childbirth, and the puerperium; diseases of the skin and subcutaneous tissue; diseases of the musculoskeletal system and connective tissue; cogenital anomalies; certain conditions originating in the perinatal period; symptoms, signs and ill-defined conditions; and injury and poisoning.

Specific to the diagnostic category, an anatomy code family may include central nervous system; head and neck; spine; upper limbs and breast having lower levels including. axilla, shoulder, arm, elbow, forearm, wrist, hand, finger and thumb; lower limbs having lower levels including hip, thigh, knee, leg, ankle, hindfoot, midfoot, forefoot, toes, thorax, abdomen, and pelvis. Each group may also have subgroups of tissue types, such as bone, joints, muscles, nerves, vessels, tendons, ligaments, capsule, and meniscus.

Examples of code groups for clinical presentations may include asymptomatic/incidental finding; developmental syndromes; pain; trauma; miscellaneous symptoms and signs; abnormal illness behavior; neurological deficits, symptoms and signs; deformity; psychiatric presentations; and intoxications.

In one embodiment, the symbolic codes may be maintainable by the user. The user may customize the codes locally at the user station, for example, to create new codes for specialized patient data that the user frequently uses or that is required for a particular task. The user may add new data options to an option list or delete data options.

Some of the categories in which data options are available often include diagnosis, treatment and outcome, in accordance with the present invention. However, other code groups may exist for various categories. Code groups relating to patient demographics may include particular codes to represent various patients' occupations. Patient data may be entered for any category or a combination of categories by using data options, from one to all available categories. In one embodiment, patient data for the treatment and outcomes categories are entered.

The diagnostic and treatment categories may include standard code sets, e.g. ICD codes and CPT codes. However, each category are often expanded beyond the level of detail provided by standard codes to include more comprehensive areas of detail under healthcare specialties, e.g. diagnostics, such as clinical presentation, pathology and anatomy. Usually two or more categories store data with symbolic codes. By comparison, other databases that use only standard coding systems, e.g. ICD codes and CPT codes, do not include codes for detailed categories such as clinical presentation, anatomy, pathology, and outcome, as may be provided by the present data analysis system.

Links are typically provided to associate related patient data within various categories. Certain data within categories for a patient management cycle may be linked within the tables storing the data. Thus, data representing the time in which the patient first presents himself/herself to a provider, e.g. admission of the patient to a facility, to the time in which treatment is completed, e.g. discharge to a follow-up period thereafter, are all associated as a “patient management cycle”. An event identifier stored in tables may provide links to related data within a patient management cycle in a data set for a patient. The event identifier is a code that represents a linking event to which other data, such as treatment and outcome data are related. The linking event is particular data in a category representing an encounter, such as a particular diagnosis for a patient. Linking fields may be provided on the data entry screens to enter the linking event data in order to link the data on the screen, as stored within a table, with other data on other screens, as stored in other linked tables. Thus, the linked tables include the event identifier for each patient management cycle for a patient.

One method of linking the data to a patient management cycle is through the use of diagnosis data as the linking event data, where a unique event identifier is provided in storage tables for each diagnoses event data entered for a patient. In one embodiment, treatment data, e.g. operations, and outcome data, including admissions data, admission outcomes score and discharge outcomes score, may be linked to specific related diagnosis for a patient management cycle. Tables for such treatment and outcome data may also include a column for the diagnoses event identifier of the related diagnosis. Furthermore, pathology, anatomy and clinical presentation data may be linked to each diagnosis data. The diagnostic data may be further linked to related clinical presentation, anatomy and pathology data. Outcome data, including outcome score as described below, may also be linked to diagnosis and treatment data. Furthermore, multimedia data may be linked to the other data within a management cycle, such as a video of an operation linked to the diagnosis and treatment. In this manner, as a user searches for data in one category by entering a criteria, the linked related patient data associated within the management cycle of the retrieved data may also be automatically retrieved for each patient that matches the criteria. For example, a user may retrieve information regarding the percentage of patients with a particular diagnosis and having a particular outcome and also having a particular clinical presentation.

In one embodiment of the analysis system, the database may include one or more sets of scores to represent a grade for the performance of the patient over time. A score may measure a patient's health at various stages, such as during admission as the patient is first presented, discharge, a short period after discharge, e.g. days or weeks and a long term period after discharge, e.g. months or years. The score is a ranking within a designated scale. The database may include one or more standard scoring system currently recognized by the particular healthcare specialty or may include scoring systems that are not yet known in the field.

The data base may include a field for data entry of such scores and link this data to other data during a patient's management cycle. The scores may be linked to one or more of the related diagnosis codes, related treatment codes and outcome codes. Thus, by retrieving score data, a user may review a set of patients having particular scores and also compare the diagnosis, treatment and outcomes of these patients.

A category may comprise a single or multiple data entry fields. One or more database forms may be used for data entry of patient data under a category. Where graphical user interfaces are employed, the category data entry fields may be depicted on a single or multiple user interface display screens. Also, separate screens may be provided for diagnosis, treatment, admissions, etc. The user interface(s) have elements to view data options stored in data option tables and to select from the data options. Under each category there may be any number of data options, which, when selected by the user, becomes patient data for a data set. The forms may be designed to mirror a healthcare professional's experience with a patient for easy data entry. Data entry fields may be arranged on a user interface screen so that the professional may enter data as data is gathered during an interaction of the professional with a patient or shortly thereafter.

The user may choose from one or more user interfaces. Any convenient user interface screens may be present containing any relevant data entry fields. For example, the selection of user interface display screens may include screens for demographics, past histories, diagnosis, clinic visits, admissions, and treatment procedures, e.g. operations. The screens may be organized in a hierarchical tree structure or linear structure. For example, a screen with fields for general data may be on one page having buttons to view subsequent pages having fields for more specific data. The screens may also be arranged in a random structure. There may further be an option, such as a control button, for a user to choose to view a screen having the minimum fields for entering only basic data or a maximum data screen that includes additional fields for entering more details.

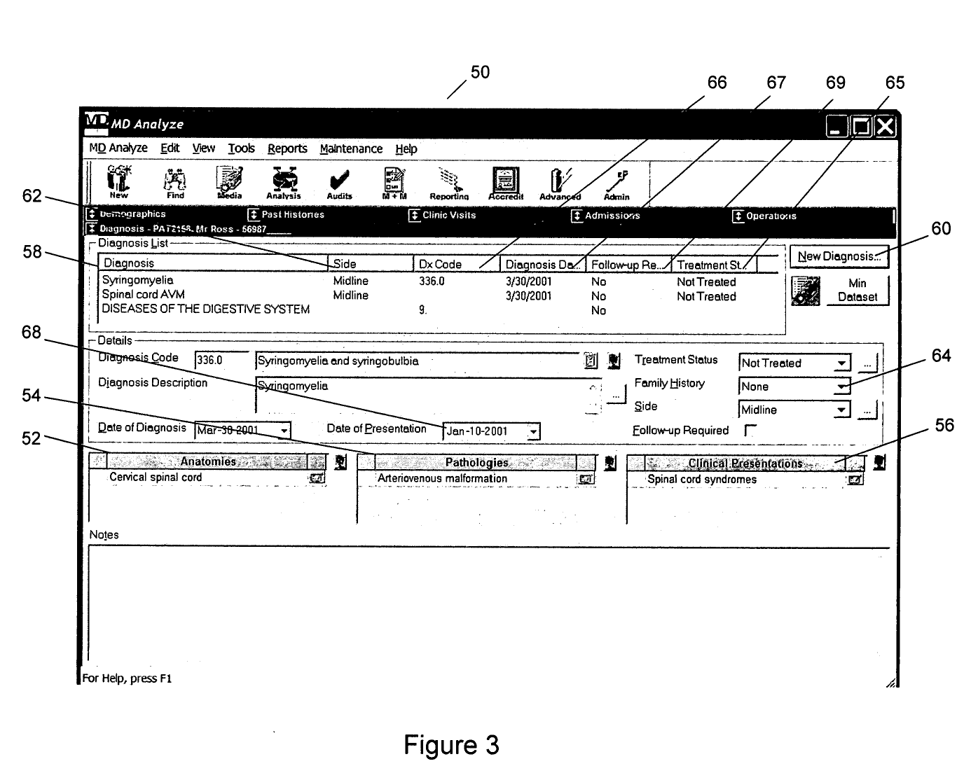

One type of screen is a diagnosis data entry screen including fields to enter data related to the disorders being treated during a particular patient management cycle. Related fields in the diagnosis screen may include diagnosis codes, e.g. ICD codes, treatment status and family history. An exemplary diagnosis data entry user interface screen 50 is depicted in FIG. 3. The diagnosis screen 50 has a diagnosis list 58 of stored diagnoses for the current data set and several fields for entering and viewing detailed information related to the diagnoses. A “Dx code” field 66 includes the symbolic code for the entered diagnosis. During data entry, as the diagnosis is selected from the data option list, which may display the list of descriptors, the associated symbolic code may automatically appear on the entry screen. Related to each diagnosis on the diagnosis screen 50 are fields for entering anatomies 52, pathologies 54 and clinical presentations 56, which allow for any number of data to be entered from a drop-down list of data options. A “general proximal location” field 62 relevant to the diagnosed condition is provided for each diagnosis as a separate field, for example entitled, “side” to further describe the diagnosis. Data options in the “side” field may include “left,” “right” and “midline,” to indicate the general location of the diagnosed condition on the body and further describe the anatomy of the diagnosis. The date of each diagnosis is entered in the “diagnosis date” field 67 as well as the presentation date to the provider in the “date of presentation” field 68. Other fields may include entering whether a follow-up to the diagnosis is required in the “follow-up required” fields 69. The status of treatment for each diagnosis may be entered as well in the “treatment status” field 65. The diagnosis screen may also have a notes field as an open-text field. A new diagnosis button 60 is provided for entering new diagnosis and diagnosis details. In addition, an indication of family history 64 may be selected as “none,” “confirmed,” “suspected” or “don't know.”

A field for “clinical presentation” 56 category of data may be provided for symptoms attributed to the diagnosis being described. Clinical presentation includes the signs and symptoms of the condition or the diagnosis of the patient. For the neurosurgery field, example clinical presentation data options may include cranial nerve palsy, branching to occulomotor or optic in the next level, painful or painless in the subsequent level, etc.

Further related to each diagnosis, a “pathology” category field 54 may be provided for data describing the etiology of the patient's condition. Pathology category data describes the causation factors for deviations from normal structure, physiology, biochemistry, cellular biology and molecular biology. The data options are typically grouped by condition type. Examples of first level data options are “genetic,” “acquired” and “environmental” etiology factors. There may be multiple influencing causes for a condition. More specific levels of pathology data options may be stroke, tumor, etc. Further narrowing levels of data options may include descriptive selections that indicate the gross appearance of the causation factor, such as type, size, shape, etc. Examples of branching levels of pathology data options in the field of neurology may include 1) arterial aneurysm; 2) berry, saccular and fusiform; and 3) large, medium and small. Data options having variable terminology, such as size, have clear definitions. In one embodiment, small is less than 10 mm, medium refers to 10-24 mm and large is greater than 24 mm.

An “anatomy” category field 52 may be included for data describing the location of the problem in the body. A top level data option may indicate a general location for the pathological condition. For example, for vascular diseases represented by the formation of an aneurysm, the anatomy category may be listed as arterial or venous anti the vessel sites, such as cardiac vein, cranial artery, etc. Subsequent levels may indicate specific vessels affected, such as internal carotid artery (ICA), anterior communicating artery (ACA), posterior communicating artery (PCA), etc. Even lower levels may further localize the precise site, such PI, P2, P3 and P4, the transverse portion of the arch of the aorta, etc.

The treatment category includes data options that describe the type of any operations or procedures performed on the patient by one or more healthcare providers. Treatments performed during multiple patient encounters may be logged. The treatment category may include data options specifying whether the treatment was performed as an in-patient procedure, e.g. admission, or out-patient procedure, e.g. clinic visit. The name of the provider performing the treatment procedure may also be specified as a data option. A data option for “none” may be included to indicate that no treatment had been performed on the patient. The treatment procedures may also be recorded against an admissions or clinic visit screen. In one embodiment, each treatment, such as an operation, is linked to multiple outcomes scoring scales, multiple diagnoses, multiple clinic visits and multiple admissions.

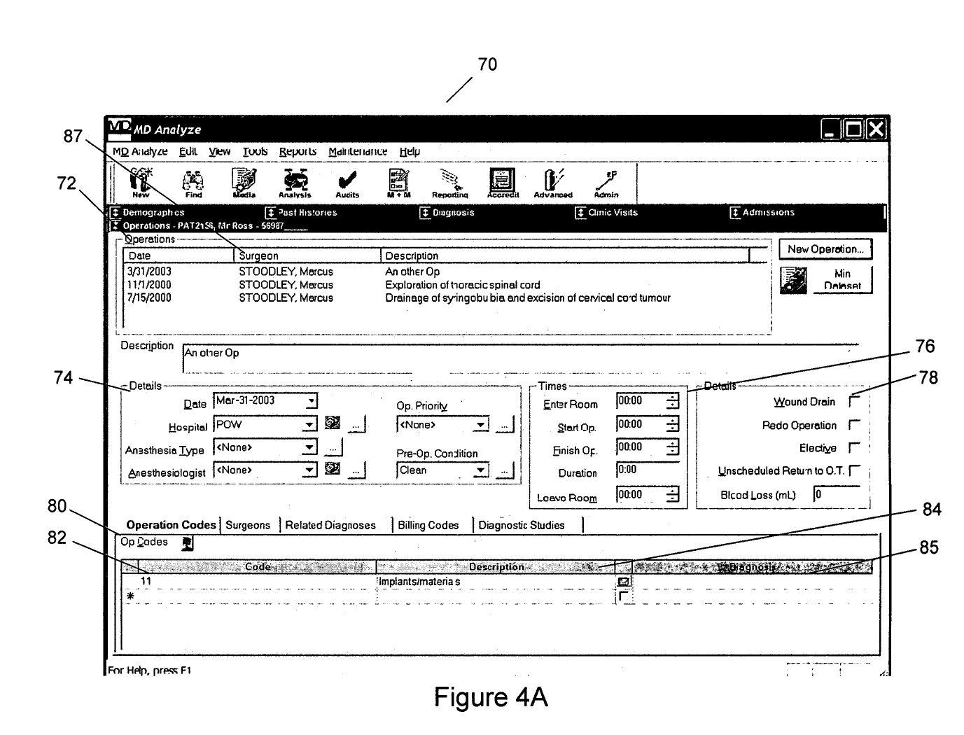

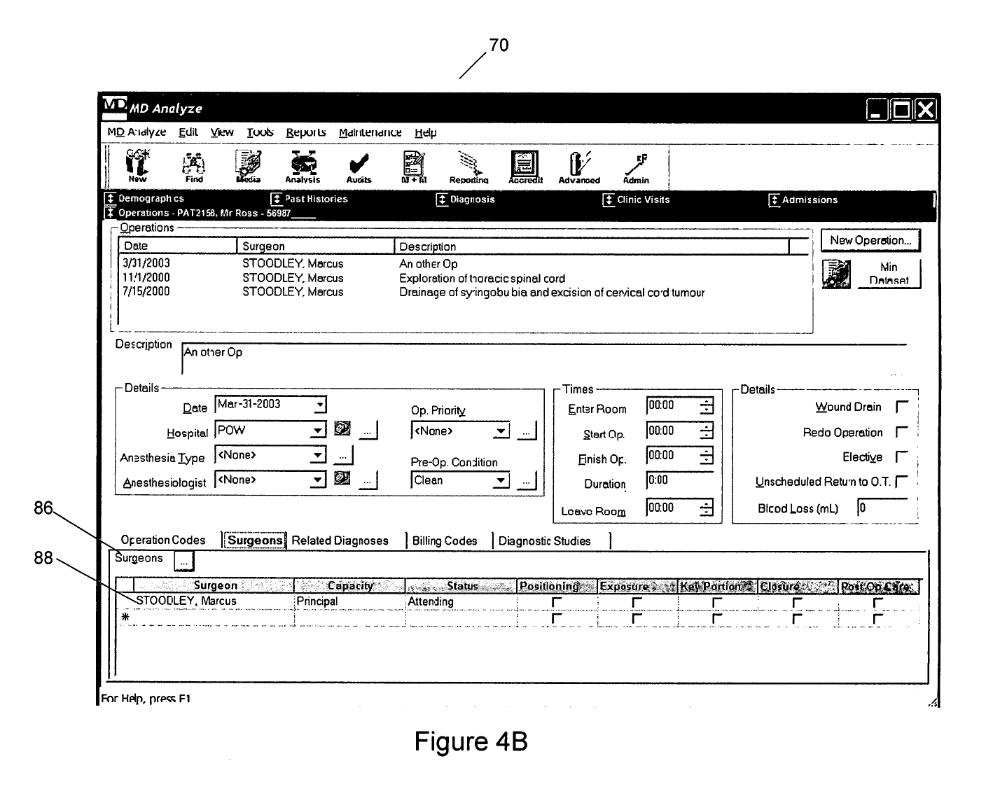

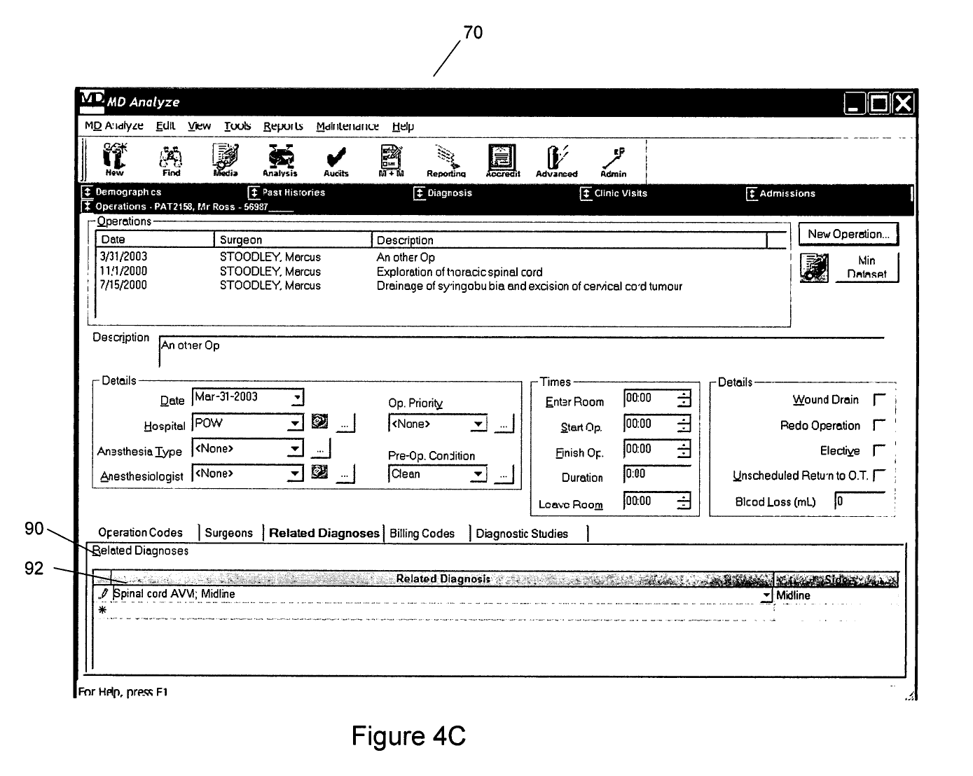

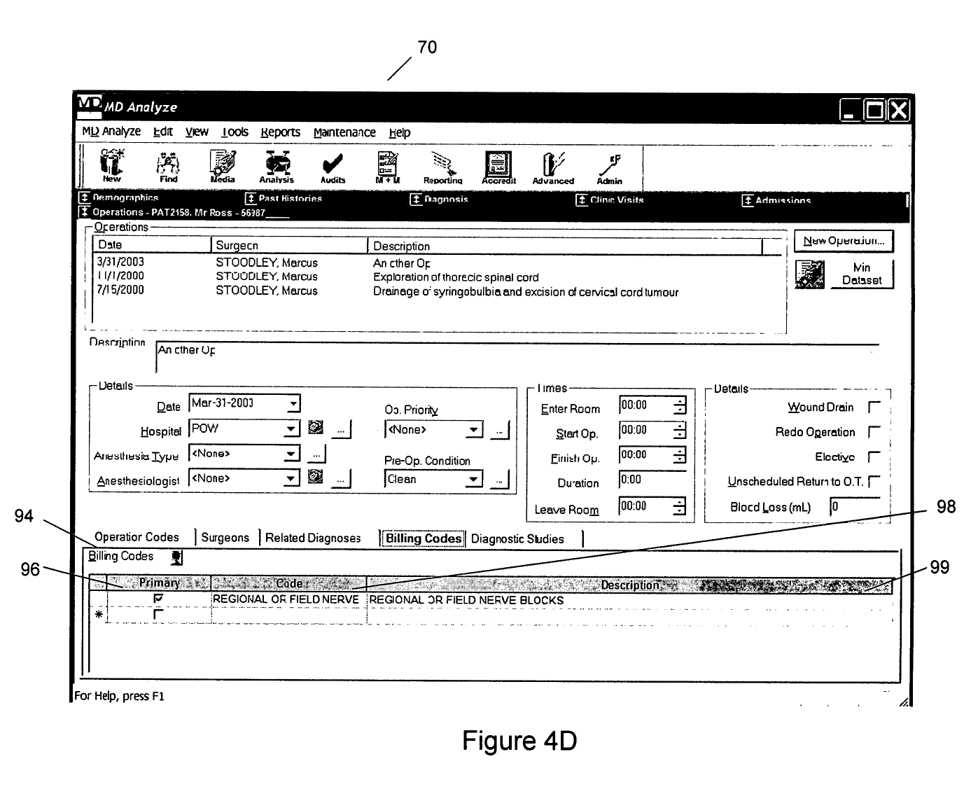

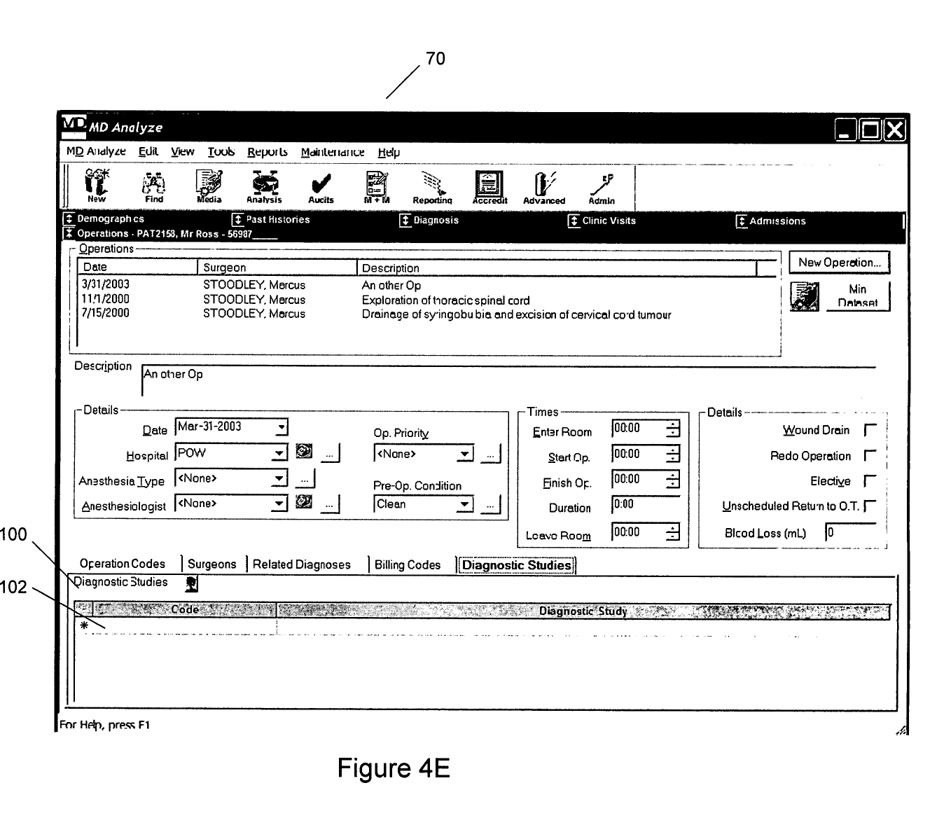

Some examples of database forms for entry of data in the treatment categories are shown variously in FIGS. 4A-4E as operation screens. The fields shown on the operation screens may also generally be included in other treatment screens. An operation screen 70 may include a “list” section 72 for a snapshot view of some basic data already entered and stored for a patient, such field may include lists for the “date of the surgery”, the “surgeon” 87 and “descriptor of the operation” that may be a text-entered generalized explanation of the treatment. For each treatment, fields may be provided for details relevant to the treatment type. For example, a pre-treatment details section 74 may include fields related to the setup of a treatment procedure such as date, hospital, anesthesia type and anesthesiologist. A time section 76 may also include the timing of key procedures, such as when the patient entered the treatment room, the start of the procedure, the end of the procedure and the duration of the procedure. A during treatment details section 78 may be also included to specify events occurring during the course of the procedure, such as whether a wound was drained, whether the operation must be repeated, elective, whether an unscheduled return to the operating theatre was required, and the amount of blood loss.

As shown in FIGS. 4A-4E, one or more windows for data entry may appear to enter details for each of the treatment procedures by selecting a detail control. FIG. 4A depicts an operation screen 70 with an “operation codes” window 80. A field for “descriptor codes” 82 and associated descriptor field 84 for which any number of data options may be selected as patient data describing an operation.

FIG. 4B shows a “surgeons” window 86. The operation screen 70 also includes data entry fields for the practitioners responsible for the procedures performed by the surgeon 88. In some embodiments, there may also be separate fields for one or more assistants during the treatment procedure FIG. 4C shows a “related diagnosis” window 90 for data regarding the diagnosis which is addressed by the treatment procedure. In the “related diagnosis” field 92, the user may elect from a list of diagnoses previously entered for the patient in the diagnosis screen 50, described above, which is the diagnosis being directly treated during the subject patient management cycle. This diagnosis field serves as a link for the treatment data entered from this screen and stored in a treatment table to the related diagnosis stored in a diagnosis table and entered in the diagnosis screen 50 described above. FIG. 4D shows a “billing codes” window 94 includes a “billing code” field 98 in relation to an associated descriptor in a “description” field 99. At least some of these codes may be standard codes, e.g. CPT codes, as recognized by insurance entities, such as Medicare. A “primary” field 96 may also be provided to specify whether the service is the primary billing service. A FIG. 4E shows a “diagnostic studies” window 100. The codes 102 may be used to record diagnostic studies which were considered in the decision to conduct a particular treatment. This rationale for the professional's treatment decision may provide supporting evidence of the standard of care used by the professional during various tasks that evaluate performance, such as quality assurance reviews, malpractice litigation, as well as during training.

In addition, a video clip taken during the procedure may be attached to the video window and the relationship of the video to the operation may be stored in the database with the patient data set. The attached video provides an invaluable record of the treatment for tasks such as training and quality improvement.

The outcome category describes the results of treatment, as well as complications that resulted. Some exemplary outcome data options may be general descriptors, such as discharge destination, e.g. “chronic care center,” “rehabilitation center,” “other acute care hospital,” “home/relative,” “died,” “don't know” and “other.” Some outcome data options may represent the state of the discharged patient, such as “dead,” “vegetative,” “disabled/assistance required,” disabled/independent” and “normal.” The outcome category may also represent more specific complications resulting from the treatment, such as pneumonia, paralysis, cranial nerve palsy. The outcome and complications codes may also be hierarchically related.

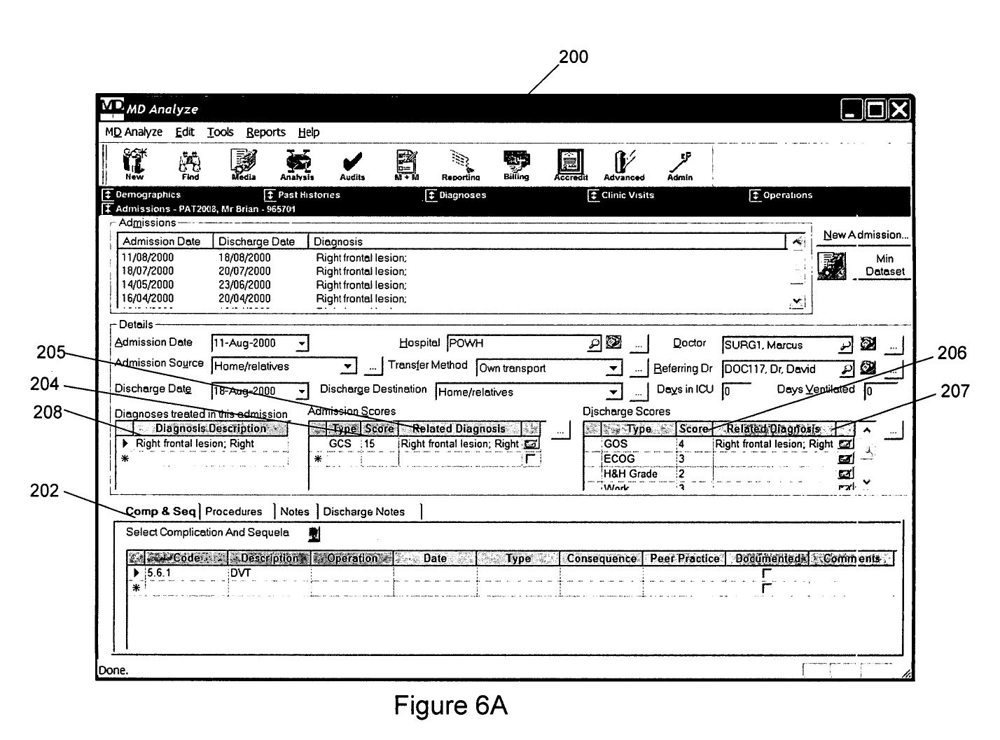

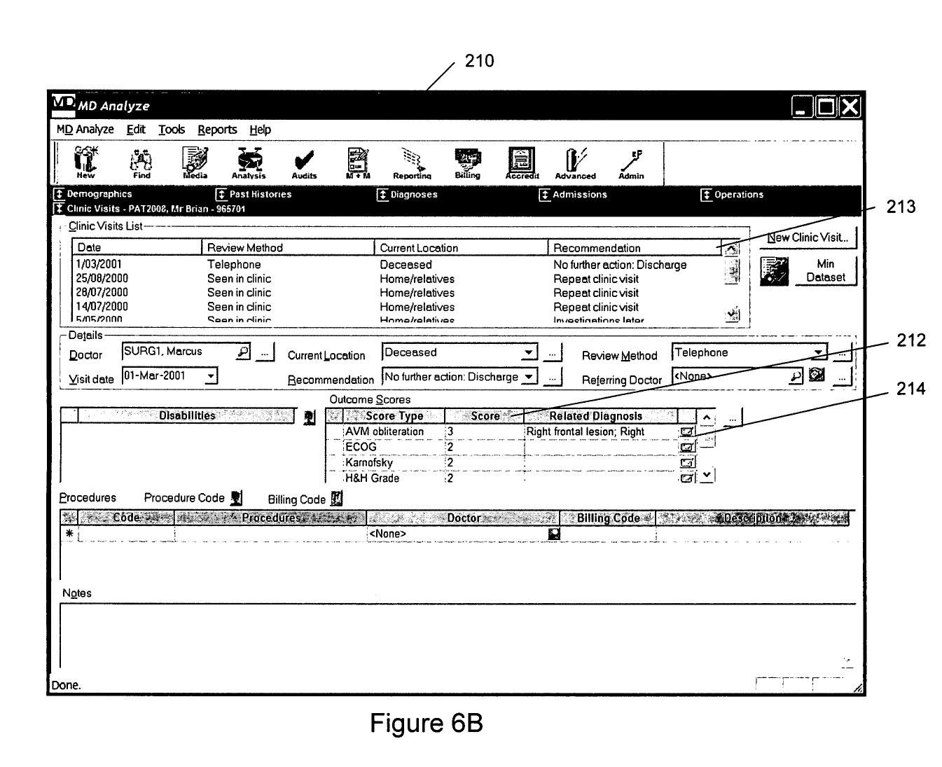

In one embodiment, screens to enter outcome data may include an admission screen and a clinic visit screen. An admissions screen 200 shown in FIG. 6A depicts some outcome fields for data related to the result of treatment. For example, a “complication and sequela” window 202 may be provided which may include a “codes” field for the outcome symbolic codes. Outcome codes, for example, may represent adverse events, i.e. complications, resulting from treatment. A “description” field may be included for entering information about an outcome or complication that is in addition to the descriptor associated with a code. This description field may permit free-text entry of data. A field may also be included to describe the consequences of the treatment. Other fields that may be included permit entry of data that may be useful during quality improvement reviews in which all complications and the consequences of treatment may be assessed. For example, a “consequence” field may include data representing the effect of treatment, e.g. whether the treatment made the patient worse, better or the same. A “comments” field may include data that compares the outcome or the performance to other expected results, e.g. whether another professional in the same circumstances would have made the same decisions or a difference decision. A “type” field may map the complication onto a short list describing the outcome, e.g. severe, minor, etc.

The admissions screen may also include additional fields to enter facts related to the admission and discharge of a patient that may be considered outcome category data. For example, “admission score” field 204 and “discharge score” field 206 may permit entry of a type and associated score for admission and discharge, respectively. The admission screen may also include an ‘admission score-related diagnosis” field 205 for diagnosis data that relate to the admission score and a “discharge score-related diagnosis” field 207 for diagnosis data that relate to the discharge score. In this manner, the admission score-related diagnosis data and discharge score-related diagnosis data, relate and link the scores to the diagnosis data entered in the diagnosis screen 50, with regard to FIG. 3, described above. In this case, the link diagnostic data is stored in a diagnosis table, as well as the tables storing the admission score data and discharge score data, as a diagnosis event identifier. Thus, these score-related diagnosis data may link to the admission and discharge scores stored in the admission table for admission screen 200 by the diagnosis event identifier.

Furthermore, the general admission data may be linked to the diagnosis data that addressed by any given admission by the data entered into the “diagnosis description” field 208. This admission-diagnosis data is also stored with an associated diagnosis event identifier.

Further to outcome data, as shown by one embodiment of clinic visit data entry screen 210 in FIG. 6B, an “outcomes score” field 212 may be provided. The clinic visit screen also includes an outcome score-related diagnosis field 214 for diagnosis data that relate to the outcome score. In this manner, the related diagnosis data in the diagnosis table that was entered in the diagnosis screen 50 with regard to FIG. 3 described above, may link to the outcome score stored in the clinic visit 210 as a diagnosis event identifier.

In general, the clinic visit screen has fields to enter data related to out-patients, which may include consultations conducted via telephone, electronic mail messages, letter, facsimile, etc. The clinic visit screen may provide a “recommendations” field 213 for data describing recommended treatments for the patient. Other fields in the clinic visit screen may include a “location” field to specify where the patient resides, a “review method” field to specify method of contacting the patient, such as via telephone, a “referring doctor” field to specify the professional that referred the patient to the professional addressing the clinic visit, and a “notes” field as an open-text field.

A past history screen assists in entering a list of conditions not directly being considered by a treating professional for a particular treatment procedure. Such past conditions may impact the severity of a condition currently being treated. The past history screen may have a “description” field in which to enter codes and/or text describing past diagnosis, treatment, etc.

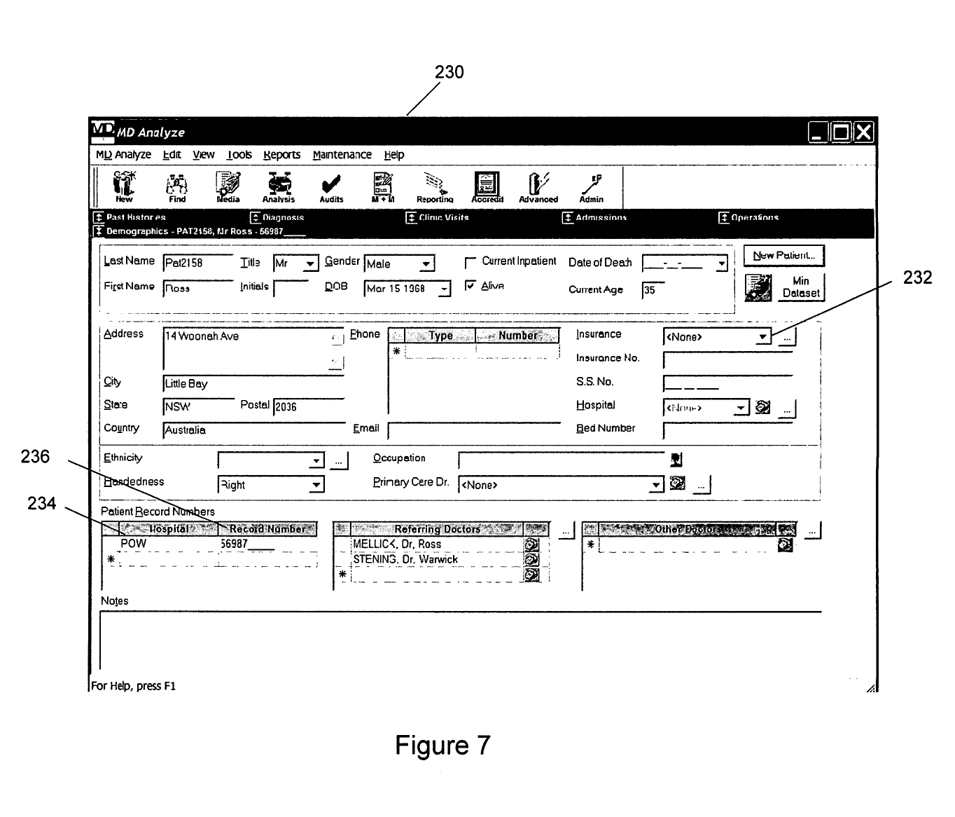

Another screen provides demographic data for a patient. FIG. 7 depicts one embodiment of demographics screen 230. Fields for demographic data may include “name”, “age”, “contact details”, insurance details, such as the “insurance company name” field 232 to be used during billing related tasks, the facility providing treatment, as the “hospital” field 234, with the treating facility's patient identifier, as the “record number” field 236, the “professional(s) providing treatment”, and the “referring doctor”.

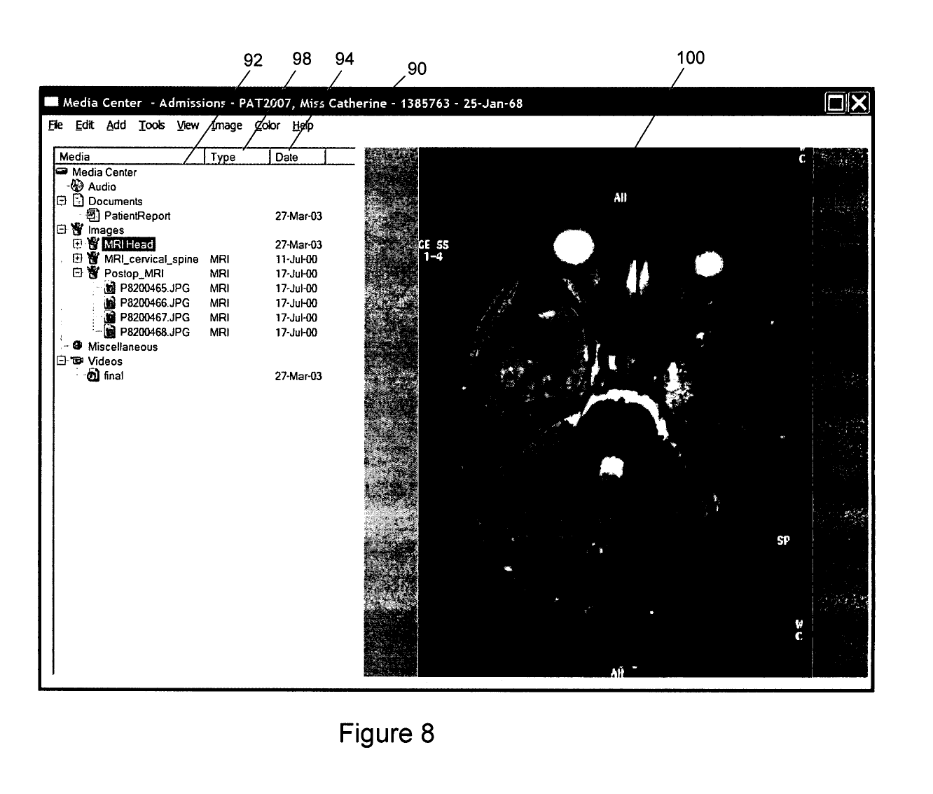

Further to variations on data entry screens, images may be inputted into an image screen 90, such as the example screen shown in FIG. 8. Text data may be entered for each image depicted as shown by the description field 92. Other fields for text data may include date 94, for the date the image was produced and image type 98. A field for image source data may also be included to allow a user to label where the image was acquired, such as a department or institution. Individual images in a study may be shown in an image window 100 by selecting the image from the list in the description 92 field. An image may be viewed in an enlarged mode such that new screen appear displaying the expanded image. New images may be imported into the database and into the image screen 90 from the storage unit in the computer platform, remotely located servers that are in communication with the user station, etc.

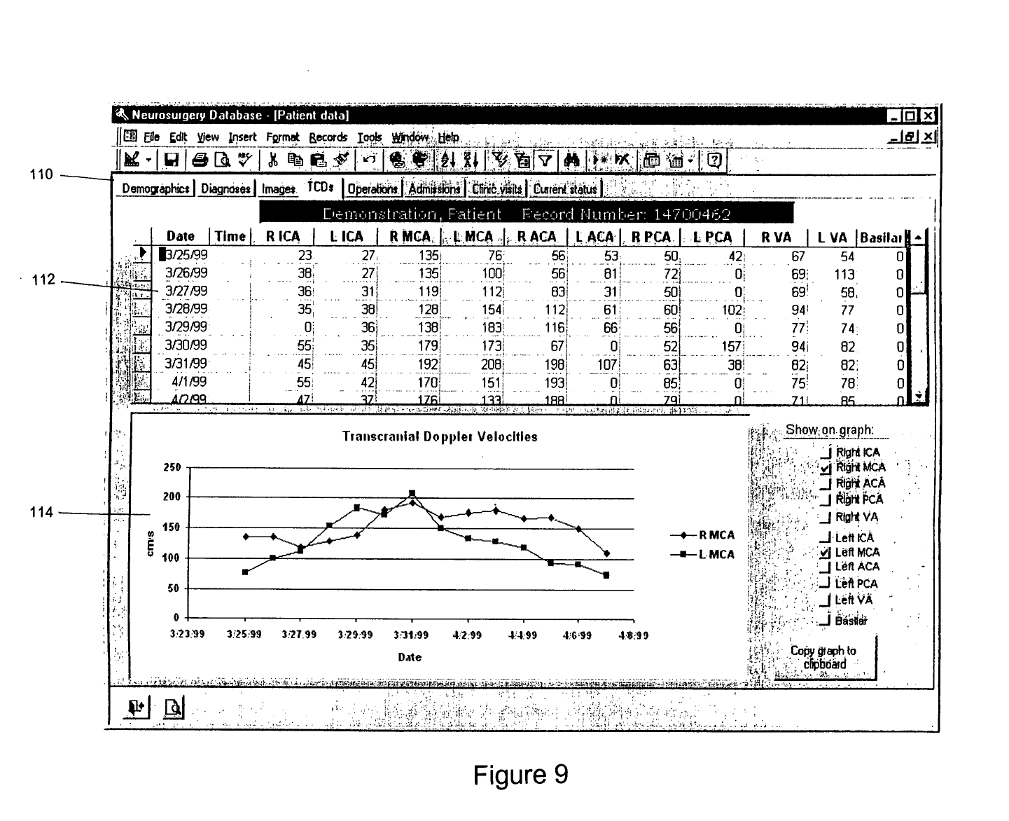

Another optional display screen shows the test results for a given patient. FIG. 9 illustrates one type of a graphic data screen 110 for the results of ultrasound studies on specific vessels in the form of transcranial Doppler velocities (TCD). The data from selected vessels are listed in table 112 and represented on graph 114. Graph 114 is a plot of velocities of blood flow rate (cm/sec) within the selected vessels over a course of dates.

Other categories of interest may be chosen to appear in the data entry screens depending on the application of the data analysis system. In some embodiments, a healthcare provider category is included to allow for quality assurance analysis of specific providers. Exemplary fields for this provider category are practitioner, institution, department, etc.

Certain field may be automatically or instructed to be prepopulated to enter default data in association with data entered in other fields. For example, when a diagnostic code and data for clinical presentation, anatomy and pathology is entered, the system may remember the data and automatically enter the previously entered clinical presentation, pathology and anatomy data when the previous diagnostic code is entered. The prepopulated data may be specific for a particular provider, where different default data is automatically entered for different providers.

Certain fields may be automatically checked for false negative entries when specified events occur. Specified data options for past history, procedures and complications can be checked whenever a discharge event occurs. This prompts the user to confirm if the specified data options are present in the patient's record.

The data may be chosen from a drop-down list of data options or entered as open text in a graphical user interface, e.g. into a note field. In addition to text data, the data options may be in various graphics and multimedia formats. The data may be in the form of images, overlays, 3-D volumes, electronic waveforms, graphs, curves, videos, sound data, or the like. The medical data may be also be DICOM compliant data (as originally published by an ACR-NEMA committee sponsored by the American College of Radiology and the National Electrical Manufacturers Association as Digital Imaging and Communications in Medicine (DICOM), NEMA Publications PS 3.1-PS3.12, by The National Electrical Manufacturers Association, Rosslyn, Calif., 1992, 1993, 1994, 1995). The display screens may include a combination of text, graphic and multimedia data. Other user interfaces may include voice interfaces in which data is entered by a voice recognition program.

During data entry through a visual user interface, the first data storage screen is usually a default screen, such as a list of stored patient data sets. The user may select a patient from the data set list in order to retrieve the stored data set for that patient. Alternatively, the user may instruct the database that a new data set is to be created for an additional patient.

Any number of data options may be selected for each category. The data options may be linearly or hierarchically related to each other. The data options may also be listed in alphabetical order, where the first portion of the option phrase is the descriptor for the first level, followed by the subsequent level descriptors in increasing order. For example, under the anatomy category, a data option may be “ICA: at posterior communicating,” where the term “ICA” is the first level and the phrase “posterior communicating” is the next lower level. Alternatively, the various levels of data may appear as separate fields on a display screen.

Furthermore, the data options also may be depicted as a visual object, such as a graphic representation of an anatomy, or a part of an anatomy. The user may conveniently make a selection by clicking on the appropriate portion of the object shown. For example, under the anatomy category, the user may select from a general portion of the body, such as an arm. The user may also select a type of system, such as a circulatory system, skeletal, etc. A detailed picture of an arm is displayed and the user may click on a target location, such as the median nerve on the upper limb.

Exemplary open text fields in the demographics screen are fields for to enter patient name, age, address, birthday, etc. Drop-down list text fields may be, for example, a list of relevant past or present illnesses or ethnicity. To facilitate data entry, as part of a data option term is entered, the database may recognize the term and automatically display the data options that complete that term, or if only one data option exists, the database may fill in the rest of the term from the list. In one embodiment, by entering the patient's date of birth the age of the patient is automatically calculated and entered in the age field.

An alternative feature of the data analysis system is an opportunity to create custom screens that include specific fields related to any data option in a category. In addition, some embodiments of the present invention provide for custom fields that may be created by a user onto an existing screen. The custom screens and custom fields allow the user to enter extra useful information associated with a selected data option. A user may custom design and store a screen or field to appear for future data entry. In order to edit fields of a screen, the user may simply instruct the system to edit fields and the user may select from a menu of stored screens. The user then may select from a menu of fields in the selected screen and enter text of the new field name. In order to create a new screen or delete a current screen, the user may instruct the system by selecting a new or delete command control. Where a new screen is desired, the user may select from a list of type of screens including anatomy, clinical presentation, pathology, operation code, and score type. The specialized screen may be created on a particular user station so that the screen relates to a particular task that a user routinely performs.

This custom screen and custom field features enable the database to be used for virtually any prospective clinical study, such as a clinical trial or testing of a new medical procedure, and store prospective patient data. Thus, in addition to conducting retrospective analyses on already stored patient data, a practitioner may use the present database to collect and analyze pertinent data on patients included in a defined study group as a clinical study is taking place. This feature is a great advantage over typical medical databases where a new and separate database must be programmed for special investigations. Separate databases used for prospective studies do not conveniently link to patient data in other databases.

The present invention provides for links between the custom data and the other patient data, such as treatment events or outcomes. The healthcare database may recognize which data options the custom screen data relates to, how to link a patient data set and when to display the custom screen during data entry. During recording of new patient data, a custom form may be linked to a particular data option by including a linking event field on the custom form, so that when the data option is chosen, the custom form automatically appears, enabling the user to enter specialized data into this custom screen. The custom form may be linked to data options in any category, e.g. diagnosis, treatment, outcomes or provider categories. In creating the custom screen, the user specifies the data option to which the custom screen relates.

To illustrate one example of a custom screen, e.g. custom prospective screen, a link may exist to the data option in the pathology category, labeled “berry aneurysm.” As the data option, “berry aneurysm” is selected by the user, a custom screen entitled, subarachnoid hemorrhage (SAH) appears allowing the user to enter data related to an SAH. In the SAH custom screen, the activity of the patient at the time of the hemorrhage may be described, as well as the specific classification of the hemorrhage and the results of procedures, such as a lumbar puncture.

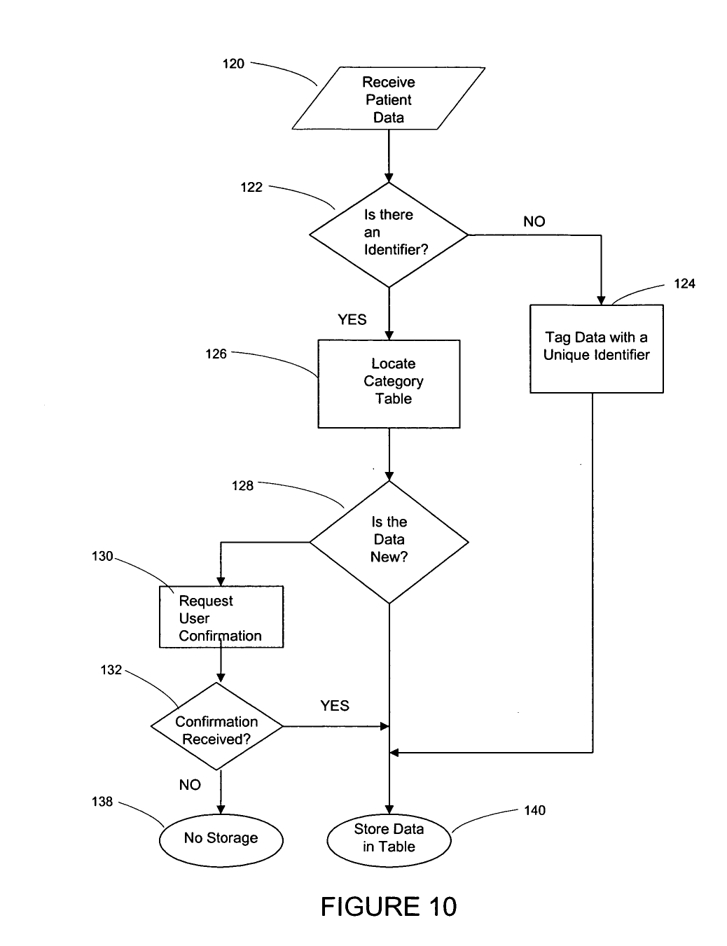

As the data are obtained from the input device and enter the platform, the data are examined by the tagging component of the database to determine the whether the incoming data are related to an existing data set or are a new data set. FIG. 10 shows one process used in the storing of entered data by the user station 10 depicted in FIG. 1. The patient data is received 120 by the analysis system 22. The analysis system checks 122 to see if the incoming data has an identifier. For example, the incoming data may include a provider-based identifier for a particular provider, which is cross-referenced with its patient identifier if one is already recorded for the patient. A table, such as the table depicted in FIG. 2 and described above may be used for this step. If there is no identifier to the data, the tagging component 24 (shown in FIG. 1) assigns 124 a new identifier to the data and places the data into storage 140. Typically, the identifier is a string of binary numbers. If the data has an identifier, the data is sent to the storage to either replace existing data from the data set or as additional information to stored data. The appropriate data table is examined to locate the appropriate category table 126 and to determine whether the incoming patient data is already present in storage or if it is new data 128. The incoming data may be a copy of data stored in a data set, such as the same treatment data option, or a duplicate of a typically unique field, such as patient name. Where the data is already a copy of stored data, the user is notified that the data is a duplicate and requests confirmation 130 that the new data should be added. If confirmation is received 132, the new data is stored 140. Otherwise, if no confirmation is received, the data is not stored 138.

It should be noted that the steps in FIG. 10 may be performed in various sequences and other steps may occur. In other embodiments, the user instructs the platform that the data is a new data set and an identifier is automatically assigned to the new data set prior to the data entering the storage unit.

In general, a relational database comprises a series of data structures in the form of tables having columns (or attributes) and rows (or tuples), containing information linked through common fields. The database uses these structures to store, retrieve and manipulate patient data. The relationships between tables are established within the database to allow particular tables (and their associated screens) to point to other tables within the database. This pointing relationship allows the particular related tables to exchange or to associate their data with each other during a data search. The database of the present invention uses the patient identifier as the key for relating tables for each data set and also may use an event identifier to link categories of data within a data set to a patient management cycle.

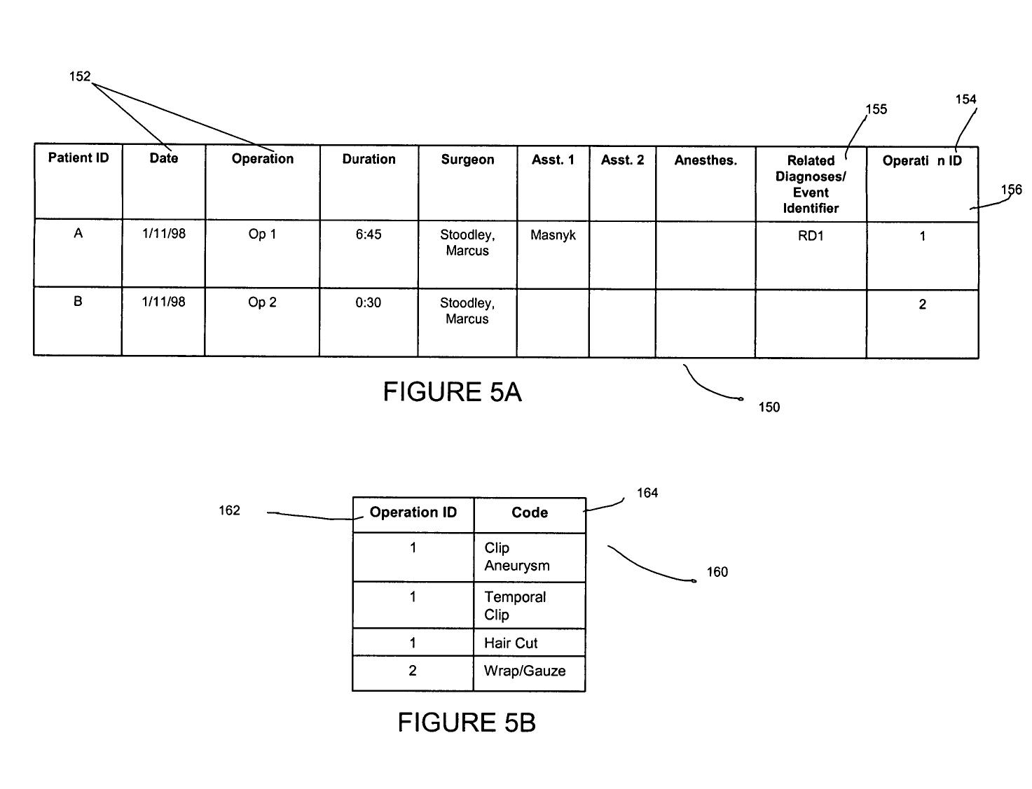

The healthcare patient data is organized by the present data analysis database into tables for each category. One type of table may be an operation table 150 for general data regarding operations for patients. In addition, an operation descriptor table 160 couples data options for operation descriptors to the general operations data, as depicted in FIGS. 5A and 5B, respectively. The operation table 150 stores patient data entered on the operation data entry screen 70, described above with regards to FIGS. 4A-4E, for each data set. In memory, the operation table 150, also relates to other tables to link the operations data to other related data in other categories. For example, the operations table links to a diagnosis table for data options selected from the diagnosis screen 50. In this manner, one may record which diagnoses an operation addresses.

The columns on the operation table 150 represent fields on the operation screen, for example, as shown in FIGS. 4A-4E. Data from exemplary single entry fields, e.g. only one datum is permitted, to be entered, are shown in single datum columns 152, “Patient ID,” “Date,” “Operation,” “Duration,” “Surgeon,” “Assistant 1,” “Assistant 2,” and “Anesthesia.” A “Related Diagnosis” column 155 is for storing the event identifier associated with the diagnosis being treated in order to link the treatment data to the related diagnosis data in the any given patient management cycle. Fields for which multiple data may be entered are shown in a related linked table. To illustrate, the column entitled Operation ID 154 contains data that is related to Operation codes table 160. Thus all operation codes 164 for patient A having operation ID 1 156, are shown in the operation table also listed as Operation ID 1 162. This link allows almost any amount of data to be entered for a given record.

There may be similar data tables for each screen, category or subgroups of data, such as demographics, diagnosis, operation, clinic visits, current status, etc. These screen data tables may be linked to category tables for fields that allow for multiple entries per record on the screen. These category data tables may include past history, clinical presentation, anatomy, pathology, treatment, such as an operation table and procedure table, diagnostic study, clinic visit outcomes score, admission and discharge outcome score, complication, disability and cause of death categories. Furthermore, specific entries in the category data tables may also be linked to custom detail tables, e.g. custom prospective tables having custom prospective data.

The data options are arranged in the data option tables according to levels in a hierarchical tree. The data in various levels of the tree maintain their relationship to data in the other levels of the tree. It is recognized that data at lower levels are more narrowly described subsets of data in higher levels of the branch. Thus, lower levels have greater detail and high levels have a greater aggregation. Data entered from custom screens also may maintain their relationship to the data located at various levels of the tree.

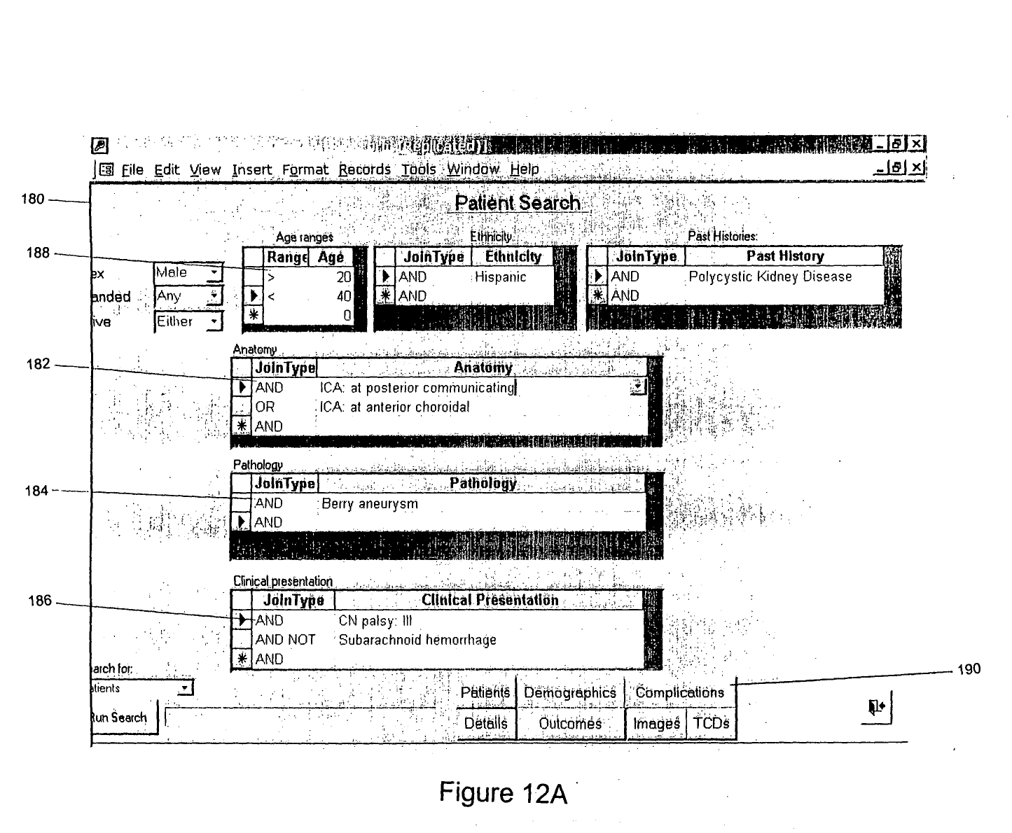

FIG. 11 shows one anatomy data option table 170 for data options in the anatomy category. The columns represent levels 172, which have various data options 174. Level 1 contains the data option, “upper limb.” The next lower level, level 2, branches into two options, “elbow” and “hand.” Level 3 contains data options “index finger” and “thumb” positioned under the “hand” branch.

All data are associated to their data set across the various tables of categories by the assigned identifier. All data of a data set, including multimedia data are related through the common identifier. Where data, such as multimedia data, are stored in a remote unit, a table is provided to cross-reference the identifier with the identification used by the remote unit. After the data are organized, the database sends the data to the storage unit where it is available for retrieval by the database.

In some embodiments, the data are further manipulated prior to storage by the processor compressing the data. Some data are very large and compression permits conservation of storage space. For example, an MRI study on a patient may include text and about 100 images, each of which may be 300 to 500 Kb in size, loading to a study of 50 to 80 Mb total of data. In the absence of compression, this large amount of data may present a particular problem for the storage of medical information.

Generally, compression formats are either high or low efficiencies. Low compression schemes, i.e. those that do not provide significant compression ratios, include graphic interchange format (GIF), bitmapped image compression schemes and tagged image file format (TIFF) compression schemes. Alternatively, high efficiency compression formats may be employed, such as wavelet, motion wavelet, Motion Picture Experts Group (MPEG) and joint photographic experts group (JPEG) schemes. Other video formats that may be supported include avi, .wav, .mp3. Video may be recorded primarily as digital files or captured from S-VHS tapes. Digital video files may be reduced in size by reducing the frame rate or reducing the quality of each frame.

Compression formats may also be either lossy or lossless. Lossy compression schemes are characterized by components of an original image being absent from a reconstructed image after a compression-decompression cycle. Lossless schemes do not surrender any information.

The healthcare profession is under a strict duty to protect the confidentiality of patients. Thus, protection of healthcare data/information is of paramount importance. The present data analysis system may include some form of security measures, such as the use of passwords. Password identification determines whether a user is authorized to gain access to the system. The system may also record an audit file for all users who access the database. Users who change any data in the system may also be recorded. Oftentimes, the system additionally resides within a facility firewall and specific rights are assigned according to an individual's job to view, enter and update data from particular data screens.

Data Searches

Once the patient data is stored within the database, a user may search for any of the patient data in any of the categories in the various display screens. This user may be the same as the user storing the data or may be a different user. An aggregate of patient data related to a group of patients may be searched. A patient group includes more than one patient and may include many patients. Usually the search is a Boolean format, but advanced search strings may also be employed. The user requests a particular search screen, for example, by selecting a search button in the main menu.

Where data in the categories are being searched, the selected categories may be chosen from the search screen. By searching under categories, patient data for all data sets in a group matching the criterion may be retrieved. The specific categories are chosen to provide the most accurate results for the analysis. Usually the search categories include one or more of diagnosis, treatment and outcome. The diagnosis category may be further divided into diagnosis groups of clinical presentation, anatomy and pathology categories. Often at least two categories, at least three or four or all available categories may be chosen. For example, a search may be conducted for diseases that have been coded with a combination of “internal carotid artery” (anatomy), “giant berry aneursym” (pathology), “painful oculomotor nerve palsy” and not “subarachnoid hemorrhage” (clinical presentation), and “craniotomy to clip aneurysm” (treatment). Such a search may be further refined to locate only those patients suffering from a particular complication of the treatment, by entering the appropriate code for complication.

The system also enables broad searches. For example, searching just for the anatomy code “internal carotid artery” will find all patients in a group having with various diseases or disorders regarding that artery, regardless of the associated diagnosis, treatment or outcome. Data entered in a custom prospective screen that is related to a data option in a category may also be included in a search.

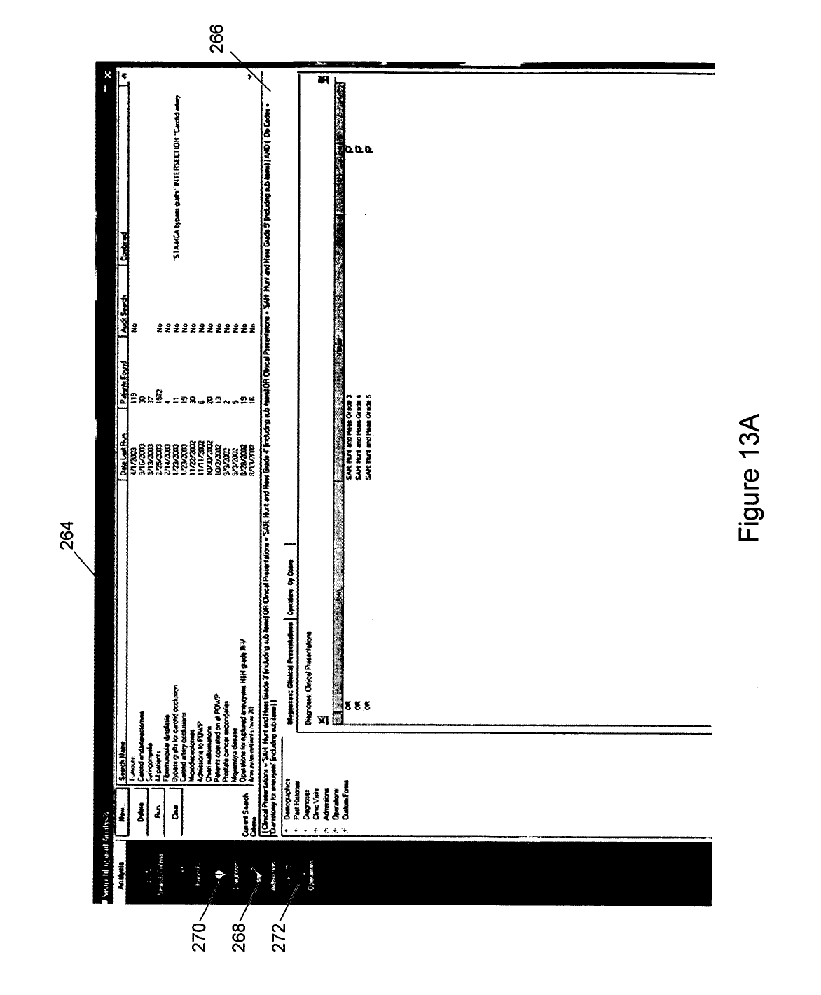

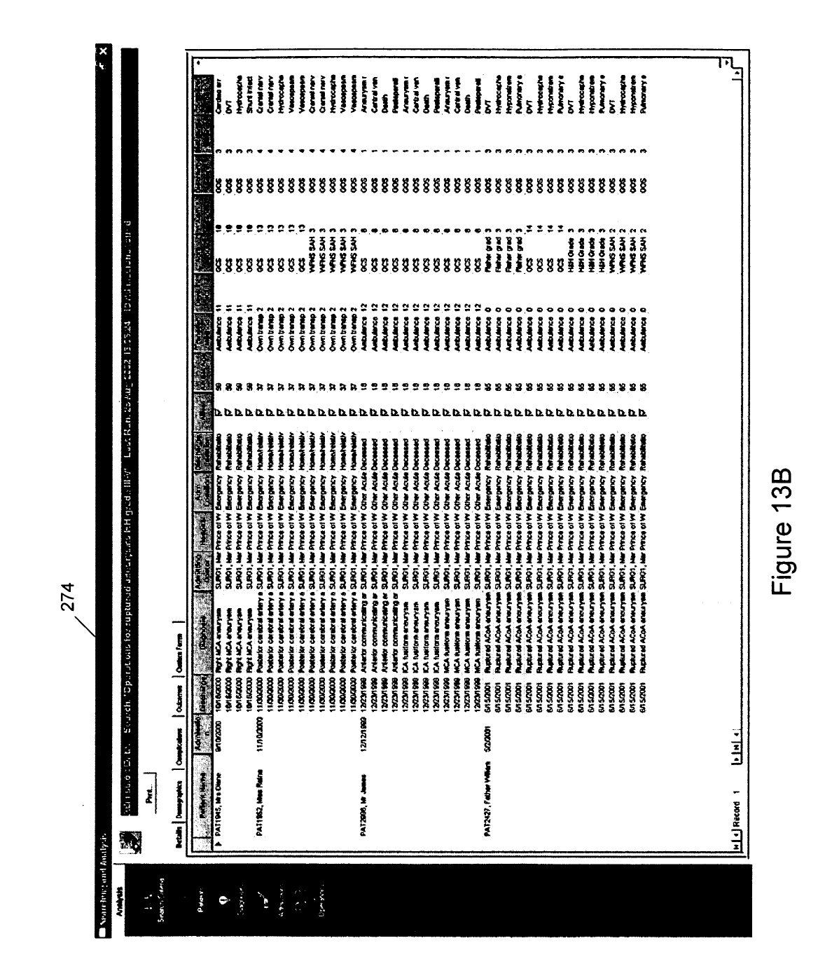

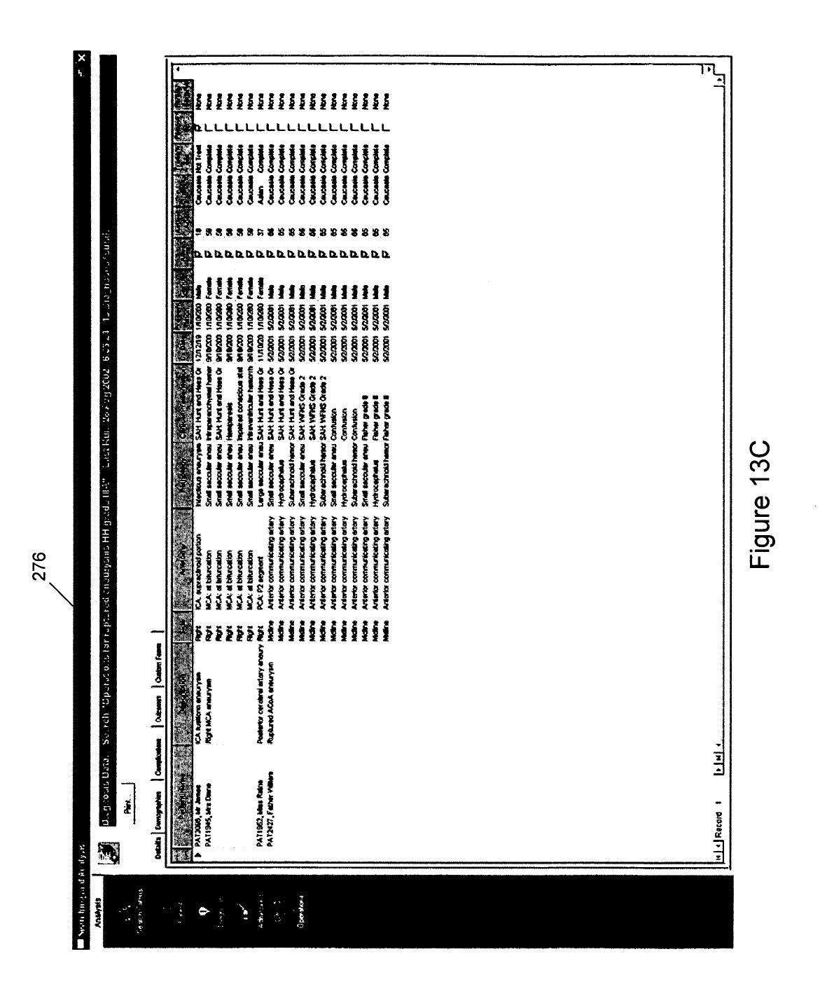

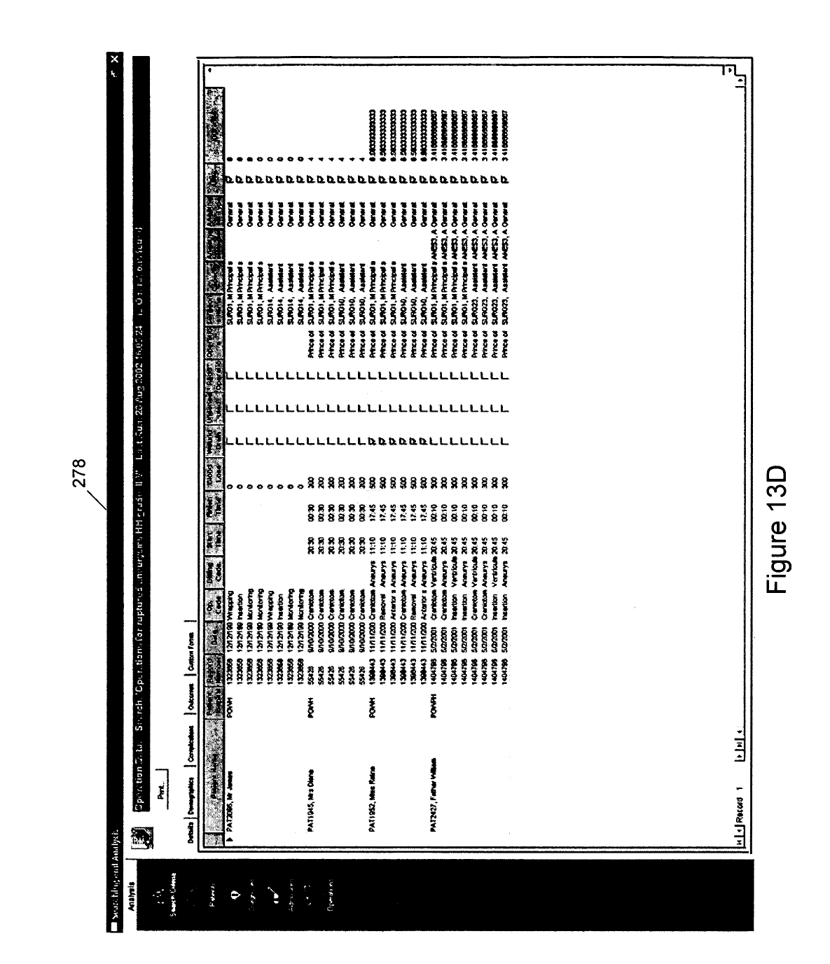

FIG. 12A illustrates one embodiment of patient search screen 180. Search categories include anatomy 182, pathology 184 and clinical presentation 186. The user may insert several search criteria for each category. A patient age criterion is specified in the age field 188 within a range by a less than and greater modifier. It is common for some demographic data to be included in the search criteria. Another useful search method allows the user to extract from a provider category, data on a particular healthcare provider, e.g. individual, department, institution, etc., or group of providers. The user may compare groups of providers with outcome results to assess quality of care rendered by a given healthcare provider. Another application of a provider search is to determine which group of individuals performs particular tasks more often. For example, in a teaching institution, the number of attending practitioners, fellows and residents performing particular operations may be determined. Another example of a search screen is shown in FIG. 13A, described below.

The present healthcare patient data analysis system and method for its use may facilitate numerous different tasks and the patient data may be available for retrieval for this variety of tasks. Some of these tasks are routinely performed at a facility. By selecting a task control from the user interface, a specialized search of data relevant to the task may be easily conducted. As shown in an exemplary main records screen 250 in FIG. 12C, a task control for analysis 252 may be provided to permit a user to enter search criteria and advance control 262 to permit special functions, such as creating custom screens and fields for specialized data entry. Furthermore, report task controls may be provided to automatically create a report summary of search results. Report controls may include audits 254, M&M 256, reporting 258, and accreditation 260. Reports may automatically also be generated at predesignated time intervals. For example, reports for M&M meetings, administrative meetings, inpatient lists, ward lists and operation lists may be created. In particular applications, the patient data that are extracted from a query search is analyzed by the database and the statistical results are optionally displayed, such as a graph form, e.g. pie chart, bar chart, etc.

At times, the data may be applied to research, such as academic research. Data patterns derived from the stored data, e.g. by data mining techniques, may be analyzed in terms of trends or associations with the use of databases. For example, by predictive modeling, data may be used to derive knowledge of relationships. In this manner, studies may be conducted to determine the viability of certain procedures. Epidemiology research may be performed and regional health statistics may be obtained with the data retrieved from the present analysis system.

Some embodiments of analysis screens are shown variously in FIGS. 13A-13D. When the system is instructed to perform an analysis, for example, when a user selects an analysis task control 252, as shown in FIG. 12C described above, an analysis screen appears. FIG. 13A shows one analysis search screen 264 in which a user may conduct a query of criteria 266 in any or all categories. The results of the search conducted in the screen shown in FIG. 13A are shown in FIGS. 13B-13D. In particular, where a user selects an admissions result control 268 on FIG. 13A, the admission related data are depicted on an admission results screen 274, as illustrated by example in FIG. 13B. Where a user selects a diagnosis result control 270, diagnosis related data are depicted on a diagnosis results screen 276, as illustrated by example in FIG. 13C. Where an operation result control is selected 272, operation results data are depicted on an operation results screen 278, as illustrated by example in FIG. 13D.

Some of the research and analysis techniques may also be used for providing quality improvement of a healthcare provider. Quality improvement processes of healthcare treatment include the assessment of many factors related to healthcare services. The level of care furnished by healthcare providers may be determined by the degree to which health services increase the likelihood of a desired health outcome. In general, level of care involves assessment of risk factors compared to outcome. The structure of care may also be evaluated by reference to the facility, the equipment, the services, the personnel available for care, and the qualifications of the involved health professionals. The process of care is another factor that includes the services provided and the process by which patients are moved through the system. Accessibility may be determined by the degree of ease or difficulty that individuals have in obtaining healthcare. Furthermore, appropriateness of care is the extent to which care complies with accepted or is within standard practice of the community, including costs and charges.

Quality improvement may involve M&M reviews and clinic/departmental audits, which may be performed on a regular basis. In performing such assessments, a user may retrieve particular patient data including outcomes score. In addition, multimedia data may be retrieved for review during an assessment meeting. Furthermore, complications may be monitored to identify adverse trends so that corrective action may be introduced. An audit may be produced simply using a range of criteria, including date range, one or more healthcare professionals, treatment, complications and sequela, and patient outcomes. The user may obtain patient data to determine annual caseload and distribution within a clinic or department. In addition, operating room issues may be addressed, such as start times, delays, etc.

In one embodiment, the patient data is retrieved for management of patients at a facility. Patient management may include inpatient, such as acute care, and/or outpatient, such as non-acute care. For example, a discharge report may be generated on a periodic basis, such as daily. The discharge list confirms that certain patients had left a facility.

The patient data that is accessible by the present system may further serve as a valuable tool for education and training of current and future professionals, such as resident and medical students, fellows and attending physicians. For training purposes, a user may, for example, retrieve patient data regarding a particular treatment including a video of the procedure. The outcomes of the treatment of interest may also be retrieved and the video of the procedure resulting in a favorable outcome may be selected for viewing. In this manner, a professional may learn techniques or helpful tips prior to performing a treatment procedure.

In addition, training of personnel, such as medical residents, often are subject to reporting requirements for evaluation of the trainee's performance. Data may be retrieved from the present analysis system for use in such reporting of data.

Healthcare professionals generally must maintain their professional licenses with specific healthcare regulating entities by fulfilling certain requirements. For example, a maintenance of certification (MOC) program has been created and is in the process of being further developed under the auspices of the American Board of Medical Specialties. One requirement is an evaluation of practice performance by a professional submitting a log of patient data for select patient cases. Outcome analysis is essential to such performance evaluation. The patient data stored and retrieved by the present invention includes all of the relevant data necessary to obtain a representative pool of patient cases in a case log that reflect a professional's practice.

In one embodiment of data analysis system, a log report of selected patient data is created for a professional. This log may be electronically transferred to a regulating body, such as through the Internet.

Related to billing purposes, a user may retrieve aggregate patient data for a group of patients related to a provider or service during a certain billing period of time. The services may be reported by transferring the data to billing forms. Where data has been reported, it may be flagged as having been reported to avoid duplicate billing for a procedure. In one embodiment, data that had been entered into an operations screen, such as the billing codes window 94 described above with regard to FIG. 4D, may be retrieved. The data may be retrieved for data collection in submitting to an insurance company or for validation of bills submitted. The data may include codes, descriptors of services, primary service indications, etc.

The present analysis system may also be used in support of clinical trials to obtain regulatory approval in some applications. Data may be retrieved for bidding on clinical trials projects, conducting the trials and analysis of clinical trials results.

Other data management tasks that may employ the present system to extract patient information includes writing research grants and other reports to solicit for funding, producing documents for litigation, complying with legislative and regulatory impositions and for governance procedures. In order to track informed consents, the present system may also include fields for entry of whether consent forms were signed and whether the professional advised the patient. In addition, other risk mitigation programs may utilize the patient data from the system. In still other applications, clinical outcomes may also be tracked with the data available for retrieval. Multimedia files may be accessed in a manner that is linked to treatment events. At least two, three, five or more of the tasks may be performed by retrieving data stored in the present analysis system. Thus, the need for multiple databases to perform different health related tasks may be obviated to store patient data with the use of the system. Still, other tasks are also intended within the scope of use for the present data analysis system.

Oftentimes, the results of an analysis study are to be presented to others in the form of a report, slide, transparency, handout, etc. For example, research studies may include incorporation of data analysis results and/or multimedia data into a paper, presentation, or the like. For convenience, the present analysis system permits a user to download the results of a search query to a graphics software application, e.g. Power Point@ by Microsoft Corporation.

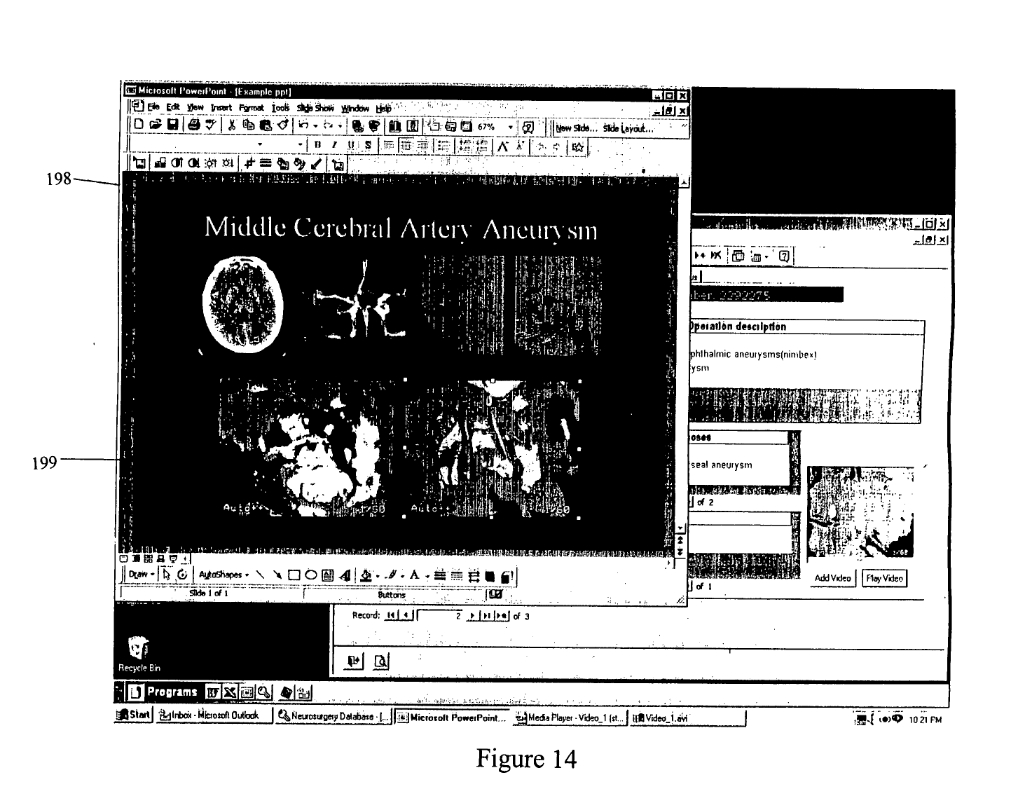

One embodiment of presentation screen is depicted in FIG. 14. Various images, as shown by example in FIG. 8, may be selected and downloaded onto presentation slide 198. Images may include radiology images or clinical photographs. Furthermore, the user may freeze a frame in a video and transfer the frame 199 to the presentation slide, or use the entire video, or portions thereof, in a computer presentation. The images may be manipulated prior to transfer by zooming, cropping, enlarging, reducing and the like.

In some particular applications of the present invention in the neurovascular surgery field, the system may produce an audit, for example, which includes aneurysm characteristics, admission grade, lengths of intensive care, hospital stay and outcome score. Outcome can be correlated with factors such as vasospasm, intraoperative blood pressure, ventricular drainage, intraoperative angiography and temporary clipping. The invention may be used to track patients with untreated problems, such as incidental aneurysms. The recorded images and video clips may be applicable in teaching or producing presentations and reports.

An advantage of the present data analysis system is that data may be cross-tabulated at any level. The user may request the data from one level and also request more specific data in from lower levels. In this manner, totals of subgroups may be compared as percentages to the overall totals of the larger group and statistical comparisons, such as Chi square tests and Student's t-test may be used on the tabulated data.

Moreover, data that are searched, retain their relationship to other levels of the hierarchical tree to which the data belongs. Where data relating to a top level are searched for, data associated with that top level are retrieved as well as data from lower levels of its branch. Thus, referring again to the anatomy data option table 170 in FIG. 11, where a search is conducted for all data associated with the hand, data that matches “hand” in level two are retrieved. In addition, the data analysis system retrieves all data entered for lower levels falling under the “hand” row, such as “thumb” and “index finger.”

Another feature is that data may be searched in various categories and across different conditions. For example, a search of all patients having conditions localized in a particular part of the anatomy may be easily collected. By comparison, databases using other coding systems, such as ICD codes, have limited searching capabilities on specific patient descriptive information. The ICD-9 or 10 coding system does not have separate categories for descriptive information, such as clinical presentation, anatomy, pathology, treatment and outcome. Rather, ICD- 9 or 10 lists all information, such as pathology combined with some anatomy information under disease states. Thus, it is difficult or impossible to search for all patients having any disease related to a specific part of the anatomy. As an example, the ICD system may code aneurysms of the ICA as one number and stenosis of the ICA as a different and non-related number. Thus, to search for all ICA related conditions, each disease must be searched in separate steps, whereas with the present invention a search for ICA retrieves all matching data in any selected categories and for any patient conditions.

A further unique benefit of the present data analysis system is that multimedia data may be retrieved based on the patient descriptive information provided with each category. The database may retrieve all multimedia data related to a data set that matches the requested criteria by corresponding identifier. In previous medical analysis systems, images are stored according to a patient identifier alone. Thus, before the present invention, one was required to first create a list of patients and then retrieve the patients' multimedia files individually. There was no way to automatically retrieve in one step, the multimedia data that match a detailed description of the patient's characteristics, e.g. anatomy, pathology, outcome, etc.

The type of requested output of information from the search results is selected by choosing from a series of “search for” options 190, such as “patients,” “demographics,” “complications,” “details,” “outcomes,” “images,” and “TCDs.” When the user station receives a search request from a user, the database searches each table for data matching the criteria. The identifier for the matched data is recognized and the “search for” data with the same identifier is retrieved.

The database performs the requested computations, such as itemizing total numbers of matching “search for” data. The output may be posted as graphic representations, such as pie charts, bar charts, graphs, etc. of the results or in the form of lists or spreadsheet tables. A summary of outcome data from an example search is shown in the screen 194 FIG. 12B having graphic representations 196 of search results.

Network System

In other embodiments of healthcare patient data analysis system, in order to avoid overloading a computer station, a client-server architecture is used, for example, where data storage, processing and control of data are implemented on a server that is in communication with the user station. Thus, a server may include a storage device and processor. Optionally, computations with the data may be performed on the server as well. In this client-server embodiment, the server is communicatively coupled to one or multiple user stations by an Ethernet connection, local area network (LAN), wide area network (WAN), the Internet, etc. Any number of facilities may use the database to access and store patient data.

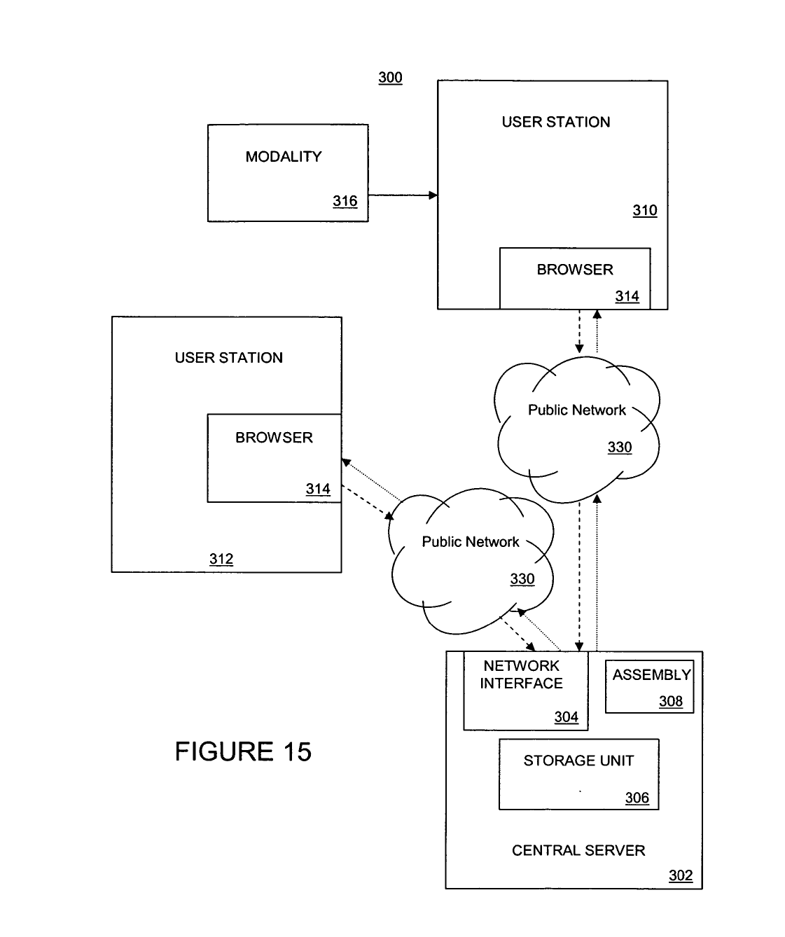

In one exemplary patient data analysis method, a server stores multimedia data for access by a remote or local user station. In another embodiment of a patient data analysis system 300 shown in FIG. 15, a central server 302 accumulates and stores all healthcare patient data that is sent by user stations 310 and 312. User station 310 may receive raw data from modality 316 and transfers the data to the server 302. The patient data may also be selected from data options as described above in the Data Storage Section. The server 302 includes a network interface 304 for acquiring the healthcare patient data through a network from each of the user stations and sending the selected portions of healthcare patient data into the network for receipt at the requesting user station. The server further has a storage unit 306 coupled to receive and to store the healthcare patient data from the network interface. The storage unit stores the patient data within tables of one or more categories including diagnosis, such as clinical presentation, pathology, and anatomy, treatment and outcome. The patient data of a data set has an attached unique patient identifier. An assembly unit 308 in the server is coupled to the network interface 304 and storage unit 306 to gather selected portions of the healthcare patient data in response to instructions from a user station. The user station may be coupled to the server by a public network 330, such as the Internet. The network may also be a virtual private network across the Internet.

In a network system, a user station may be provided having an input device for receiving patient data. A processor in the user station has a means for receiving patient data from the input device. The patient data is at least one chosen data option from a category in a tree format as described above. The category is also selected from the group including diagnosis category, e.g. clinical presentation, pathology, and anatomy, treatment category and outcome category. The process also typically has a means for forming instructions by selecting at least one criterion from at least one of the categories.

In one embodiment, the user stations 310, 312 may communicate to the central server 302 with use of a browser 314, i.e. Web browser software. The browser 314 issues a request, such as an HTTP request, for a particular user interface, e.g. a Web page. The browser 314 is also used in viewing the user interface. Commercially available browsers include Netscape Navigator@ from Netscape Corporation located in Mountain View Calif.; Internet Explorer@ from Microsoft Corporation located in Redmond Wash.; and Lotus Notes@ from Lotus Development Corporation located in Cambridge, Mass.

A user may request selected data through a search query, as described above for a client-based system. However, in one method of conducting a search, the user must first transfer their patient data to the central server prior to conducting such a request. An activation unit in the server may be present to determine whether patient data were received from a user station prior to the user sending instructions for selected portions of patient data. Thus, upon requesting a search, the user is prompted to transmit patient data from the user station to the server.

One method of exchanging healthcare patient data across a network involves the user station assembling data into packets. The packets having the patient data are sent into the public network by the user station for receipt at the server. Thereafter, the selected patient data is received from the server. The user may also retrieve certain aggregate patient data from the server by selecting criteria from at least one of the patient descriptive categories, including past history, clinical presentation, anatomy, pathology, treatment, such as an operations table and procedures table, diagnostic study, clinic visit outcomes score, admission and discharge outcome score, complication, disability and cause of death categories. The user then sends a request for the selected patient data associated with the criteria to the server. The server receives the request and retrieves the appropriate patient data in a manner similar to the method used by the user station described above. The server transfers the patient data for all data sets in a group common to the criterion back to the user station or other destination, which may be designated by the requesting user station.

In this manner, any number of user stations may be members of a healthcare network enterprise and access a central collection of patient data stored in a server. A given user station may have access to enormous amounts of patient data from healthcare sources anywhere in the world. In one embodiment, the data may be entered in any language.

At times, the network data analysis system may serve multiple functions or may provide special functions, such as accumulation of accreditation related data for professionals to fulfill licensing requirements. In this example of special function systems, the user interface to enter data into the database may be accessed through the Internet and case logs for professionals may transferred from the user station to the server via the Internet, including through a browser or email. In another application, data from multiple practitioners are accumulated for defined clinical trial studies. In still other applications, audits and quality assurance activities may be conducted on specific healthcare disciplines.

In order to protect the confidential nature of the patient information, usually the patient data set is stripped of data that may identify the individual patient. For example, the patient's name, address, social security number, etc. is protected. There are several ways of securing this personal data. In one embodiment, the personal data is not forwarded to the central server. Alternatively, the central server may receive the personal data and remove this data from the data set prior to storing the data. In other cases, the central server may store the personal data but restrict access to the sensitive data, such as by removing the personal data from the selected data prior to sending the data to a user station.

To further protect the transferred data, the user station may encrypt the data prior to data transmission. A variety of encryption schemes may be used, such as public key encryption or private key encryption. The encryption components may be stand-alone components or software components executed by the processor in the user station. The central server includes a decryption unit for decrypting the received data prior to storage.

To make transmission more efficient, the data may be compressed prior to sending. The compression schemes employed may be similar to the compression formats used prior to storage as described above.

The present invention has been described above in varied detail by reference to particular embodiments and figures. However, these specifics should not be construed as limitations on the scope of the invention, but merely as illustrations of some of the presently preferred embodiments. It is to be further understood that other modifications or substitutions may be made to the described information transfer system as well as methods of its use without departing from the broad scope of the invention. Therefore, the following claims and their legal equivalents should determine the scope of the invention.

What is claimed is:

1. A method of analyzing healthcare patient data, the method comprising:
providing a database including patient data of data sets, each data set being for a different patient and having a unique patient identifier, the patient data being located in tables of categories including at least two of diagnosis, treatment, and outcome, wherein the patient data within the categories are stored as selected data options and the patient data of a data set relate by the patient identifier;
receiving at least one criterion for patient data located in at least one category;
determining patient data results for all data sets in a group common to the criterion; and
presenting the patient data results.

2. The method of claim 1, wherein at least some of the patient data include symbolic codes to represent descriptors, wherein each symbolic code represents a descriptor in more than one language.

3. The method of claim 1, wherein the diagnosis category includes at least one of anatomy, pathology and clinical presentation category.

4. The method of claim 1, wherein the treatment category includes at least one of operation, procedure and diagnostic study category.

5. The method of claim 1, wherein the outcomes category includes at least one of clinic visit outcomes score, admissions outcomes score, discharge outcomes score, complication, disability and cause of death factor category.

6. The method of claim 1, further comprising retrieving multimedia data related to the patient data results by the identifier.

7. The method of claim 1, further comprising creating a report for at least two of audit, mortality and morbidity, reporting, discharge list, and accreditation case log.

8. The method of claim 1, wherein the patient data results are related to at least two tasks of a group of tasks consisting of patient management, clinical outcomes tracking, healthcare research, training of healthcare professionals, fulfilling certification or accreditation requirements, clinical trials, quality improvement assessment, informed consent tracking, risk mitigation assessment, access to multimedia files linked to treatment events, data collection for export to other database systems, and billing.

9. The method of claim 8, wherein the patient data results is related to at least three of the tasks.

10. The method of claim 8, further including transferring the patient data results to a form for patient management, clinical outcomes tracking, fulfilling certification or accreditation requirements, clinical trials, quality improvement assessment, informed consent tracking, risk mitigation assessment, and billing.

11. The method of claim 1, wherein the patient data results include at least one level of a category hierarchical tree having data options arranged in increasing levels of specificity.

12. The method of claim 11, wherein the patient data results include patient data common to the received criterion and criterion from lower levels of the hierarchical tree.

13. A method implemented in a computer system for organizing healthcare patient data in a database, comprising:
receiving selected patient data from data options in at least one category including diagnosis, treatment and outcome;
storing in the database, the patient data with a unique patient identifier to relate the patient data within a data set, each data set being for a different patient; and
storing a linking event identifier for linking event data to link at least some of the patient data related to a patient management cycle.

14. The method of claim 13, wherein the linking event data is diagnosis category data and the linked data are in the treatment category and the outcome category.

15. The method of claim 14, wherein the linked data include outcome score in the outcome category.

16. The method of claim 14, wherein the linked data include admission score and discharge score.

17. The method of claim 13, wherein the patient data is related to at least two of tasks including patient management, clinical outcomes tracking, healthcare research, training of healthcare professionals, fulfilling certification or accreditation requirements, clinical trials, quality improvement assessment, informed consent tracking, risk mitigation assessment, access to multimedia files linked to treatment events, data collection for export to other database systems, and billing.

18. The method of claim 17, wherein the patient data is related to at least three of the tasks.

19. The method of claim 13, further comprising storing symbolic codes to represent descriptors, wherein each symbolic code represents a descriptor in more than one language.

20. The method of claim 19, wherein at least one of the symbolic codes are created by a user storing the patient data.

21. The method of claim 13, wherein the patient data is stored for more than one provider.

22. A computer readable medium having stored therein a plurality of sequences of executable instructions, which, when executed by a processor, cause a healthcare data analysis system to:
receive selected patient data from data options in at least one category including diagnosis, treatment and outcome;
store the patient data with a unique patient identifier to relate the patient data within a data set, each data set being for a different patient,
store a linking event identifier for corresponding linking event data to link at least some of the patient data related to a patient management cycle.

23. The computer readable medium of claim 22, wherein the linking event data is diagnosis category data and the linked patient data are in the treatment category and the outcome category.

24. The computer readable medium of claim 23, wherein the linked patient data include outcome score in the outcome category.

25. The computer readable medium of claim 23, wherein the linked patient data include admission score and discharge score.

26. The computer readable medium of claim 22, wherein the categories further include at least two of past history, clinical presentation, anatomy, pathology, diagnostic study, clinic visit outcomes score, admission outcome score, discharge outcome score, complication, disability and cause of death.

27. The computer readable medium of claim 22, further including symbolic codes for at least some of the patient data related to at least two categories including diagnostic, clinical presentation, anatomy, pathology, and outcome.

28. The computer readable medium of claim 22, further including additional sequences of executable instructions, which, when executed by the processor further cause the system to perform at least two tasks of a group of tasks consisting of patient management, clinical outcomes tracking, healthcare research, training of healthcare professionals, fulfilling certification or accreditation requirements, clinical trials, quality improvement assessment, informed consent tracking, risk mitigation assessment, providing access to multimedia files linked to treatment events, export of collected data to other database systems, and billing.

29. The computer readable medium of claim 28, wherein at least three of the tasks are performed.

30. A healthcare data analysis system for patient data analysis comprising:
a processor;
an input device in communication with the processor for receiving patient data;
a storage unit in communication with the processor having a relational database for:
(i) storing data options within data option tables by increasing levels of specificity in a hierarchical tree, the data option tables being for diagnosis, treatment or outcome, and
(ii) storing patient data of data sets within category tables, each data set being for a different patient and having a unique patient identifier, the patient data being selected from the data options in at least one data option table,
the processor comprising a means for receiving patient data from the input, storing the patient data in the storage unit and linking patient data of a data set from the categories for a patient management cycle.

31. The system of claim 30, further including at least one user interface to allow a user to selectively view data options to be selected by the user and entered through the input device as patient data.

32. The system of claim 31, wherein the at least one user interface is to further permit a user to view selected patient data for all data sets in a group matching a criterion.

33. The system of claim 31, wherein separate user interfaces are provided for patient data related to demographics, past histories, diagnosis, clinic visits, admissions, and treatment procedures.

34. The system of claim 33, wherein the user interface screens for clinic visits, admissions and treatment procedures include linking event fields related to a diagnosis linking event data of a patient management cycle.

35. The system of claim 32, wherein at least one data option is related to custom prospective data in a custom screen table.

36. A healthcare data analysis system comprising:
a database having patient data of data sets, each data set being for a different patient and having a unique patient identifier stored within category tables, the patient data being chosen from data options in at least one data option table being for diagnosis, treatment and outcome, and
at least one user interface to allow a user to selectively view data options to be selected by the user and entered through the input device as patient data.

37. The system of claim 36, wherein the at least one user interface is to further permit a user to view retrieved patient data for all data sets in a group matching a criterion.

38. The system of claim 36, wherein separate user interfaces are provided for patient data related to demographics, past histories, diagnosis, clinic visits, admissions, and treatment procedures.

39. The system of claim 36, wherein at least one of the user interface is created by the user and linked to a data option of another user interface.
